(19) United States
(12) Patent Application Publication
(10) Pub. No.: US 2007/0036434 A1
(43) Pub. Date: Feb. 15, 2007

(54) Topology-Based Method of Partition, Analysis, and Simplification of Dynamical Images and its Applications

(76) Inventor: Peter Saveliev, Huntington, WV (US)

Correspondence Address: BRUCE E. HAYDEN, P.C., P.O. BOX 205, DILLION, CO, 80435-0205, US

(21) Appl. No.: 11/461,479

(22) Filed: Aug. 1, 2006

Related U.S. Application Data
(60) Provisional application No. 60/708,228, filed on Aug. 15, 2005.

(51) Int. Cl. G06K 9/34

(52) U.S. Cl. 382/173

(57) ABSTRACT

A dynamical image of is an array of black-and-white images, or frames, of arbitrary dimension. Dynamical images are constructed from gray scale and color images, video sequences etc. A method of topological analysis and decomposition of dynamical images through computation of homology groups of the frames is provided. Each frame is partitioned into a collection of components, which, in turn, have tunnels, voids, and other higher dimensional cycles. The cycles in each frame are linked to the cycles in each adjacent frame to record how they merge and split. Further, the dynamical image is simplified by removing from frames all cycles that are small in terms of length, area, volume, etc, or lifespan. Applications of the method lie in image enhancement and restoration, motion tracking, computer vision, surface and curve reconstruction, scientific image analysis, image recognition and matching.

### CROSS REFERENCE TO RELATED APPLICATIONS

This application is a continuation-in-part and claims priority for the material in our provisional patent application titled: “Topology Based Method of Partition and Simplification of Dynamical Images”, filed Aug. 15, 2005, and assigned to the assignee hereof.

### BACKGROUND OF THE INVENTION

1. Field Of The Invention

The present invention generally relates to computer imaging and, more specifically, to methods for partition and simplification of images, image enhancement, motion tracking, computer vision, triangulation, surface and curve reconstruction, visualization, scientific image analysis, image recognition and matching.

2. Description of Related Art

Applications of Homology Theory in Imaging.

Consider the following 3 questions. How do you teach a computer to count the number of objects in a picture? How can you make a computer distinguish between letters P and B or recognize how many tunnels there are in a human bone or a molecule? How many voids there are in a piece of an alloy?

These and related issues are studied in the area of mathematics called algebraic topology (“Topology and Geometry” by G. Bredon, Springer Verlag, 1993., herein incorporated by reference) specifically, homology theory. Homology theory can answer the three questions above by finding explicit representations of the necessary features, called homology classes, of the images. Specifically, for each of the three situations it finds “cycles” of dimensions 0 (components), 1 (holes or tunnels), and 2 (voids). The number of different cycles in each dimension is captured by the Betti numbers, B₀, B₁, B₂, . . . . For example, for the donut these numbers are 1, 1, 0, . . . For the inner tire, they are 1, 2, 1, 0, . . .

These techniques have been available since long before the proliferation of computers and digital imaging. Homology software is also currently available (CHomP www.math.gatech.edu/˜chomp, PLEX math.stanford.edu/comptop/programs/plex, GAP www.cis.udel.edu/˜dumas/Homology). In spite of these facts, homology theory has not been broadly used in the current imaging technology. One of the reasons is that these techniques are applicable to “sets”, or, more narrowly, cell complexes. From the point of view of imaging, these are binary still images. Therefore, there is an immediate need to make algebraic topology applicable to, first, gray scale and color images and, second, video sequences. Of course, one can obtain a binary image from a gray scale image by thresholding, but this may lead to an unacceptable loss of information.

Further, one needs to extracts objects from the picture or a 3D image by finding their boundaries, measure, compare, and identify them. The output is used for enhancement, simplification, and further analysis of images. With the proliferation of digital imaging as well as more and more powerful and cheap computers, the demand for such software is and will be increasing.

Some of the above problems are treated by methods well-known in the imaging industry. The first drawback of these methods, however, is their narrow applicability. A given method applies to 2D images but not 3D images, or to point clouds but not digital images, or to still images but not movies, etc. Many significantly depend on the context. Therefore, there is a need for a simple, yet unified way to deal with all of these applications.

Currently, the user has mostly qualitative tools available for the study the topology of the image. Quantitative description has been missing or insufficient. In scientific settings, it is often necessary to provide the researcher with numerical characteristics of the image, i.e., the number of components, tunnels, and voids. For example, these numbers may reflect the strength of a bone or other material. Geometric measures of these features may also be useful.

U.S. Pat. No. 5,784,540 titled “Systems For Solving Spatial Reasoning Problems Via Topological Inference” by Boi Faltings applies 0^{th} and 1^{st} homology groups to facilitate spatial reasoning problems. Another known application of algebraic topology to image analysis is U.S. Patent Application No. 20050232511 titled “Image Model Based On N-Pixels And Defined In Algebraic Topology, And Applications Thereof”. Its scope, however, is limited to improvements of imaging methods based on partial differential equations (“PDEs”).

The Alpha-Shapes Method.

The most natural way of modeling protein's molecular structure is via 3-dimensional simplicial complexes, as follows. Each atom is a point in space and a vertex in the complex. If the distance between two atoms is less than a certain number, they share electrons and are connected by a bond. This bond is represented as an edge. If three atoms share electrons, they are connected by a triangle. As a result, we obtain the Delauney triangulation of this collection of balls (See U.S. Pat. No. 6,182,016 titled “Molecular Classification for Property Prediction” by Jie Liang, et al. “An incremental algorithm for Betti numbers of simplicial complexes on the 3-sphere” by C. J. A. Delfinado and H. Edelsbrunner, in Comput. Aided Geom. Design, 12 (1995), pp. 771-784, and “Three-Dimensional Alpha Shapes” by H. Edelsbrunner and E. P. Mucke in ACM Trans. Graphics 13 (1994), 43-72, all herein incorporated by reference). This combination of vertices, edges and triangles is called a simplicial complex. More generally, this approach provides a representation of a point cloud as a simplicial complex.

If we are interested in large-scale features of the molecule, we then apply the so-called alpha-shapes method. For each positive number alpha, one constructs the Delauney triangulations of a system of balls each with the radius equal to the radius of the atom plus alpha. As the balls grow, new vertices, edges, and faces appear. As a result, the complex grows and some features (specifically, tunnels and voids) appear and disappear, components merge. Such a growing sequence of simplicial complexes is called a filtration. The incremental “persistence” algorithm processes this sequence and calculates the lifespans of the features. The lifespan, time of death−time of birth, is called the persistence of the feature. The larger it is, the more important is the feature. More generally, computational geometry studies “point clouds”, i.e., collections of points in the Euclidean space often obtained through sampling. The persistence technique makes possible discovering topological (letter “O”) as well as “almost topological” (letter “C”) features of the geometric object behind the point cloud. On a large scale, it is important to know whether a protein is ring-like or hand-like as this may be the way it binds to other molecules.

A similar sequence of 3D simplicial complexes is given by flow shapes. However, they are homotopy equivalent to alpha-shapes (“Alpha-Shapes And Flow Shapes Are Homotopy Equivalent”by T. K. Dey, J. Giesen, and M. John, in Proc. Sympos. Theory Computing (STOC 2003), pp. 493-502).

First, the persistence approach should be made applicable to color images. A step in this direction is made in “Stability Of Persistence Diagrams” by D. Cohen-Steiner, H. Edelsbrunner, and J. Harer, in “Proc. 21st Sympos. Comput. Geom. 2005”, pp. 263-271, incorporated herein by reference, where the persistence of sub-level sets of some continuous functions is considered. If this function is the gray level, the persistence of a feature is its contrast. To analyze color images, vector-valued functions have to be 5considered. Second, for point clouds persistence is clearly affected by the size of the feature, therefore other versions of persistence are necessary, especially for digital imaging. Third, the idea of persistence has only been applied to growing complexes, i.e., ones that are gaining vertices, edges, etc. Thus, it needs to be generalized to be applicable to analysis of videos, where complexes may also be loosing vertices, edges, etc. Fourth, most importantly, the alpha-shape algorithm does not find representative cycles of the homology groups but only simplices the addition of which creates or destroys these cycles. This information alone does not allow one to measure these cycles nor visualize them. Therefore, there is a need for explicit computation of generators of the persistent homology groups in this, generalized setting.

Further, digital images normally come in the grid form, which does not lend itself to an easy representation as a simplicial complex. In fact, organized, grid-like, point clouds present a challenge to the alpha-shapes method. An alternative is cubical complexes, where every pixel is represented by a square, every voxel by a cube (“Computational Homology” by T. Kaczynski, K. Mischaikow, and M. Mrozek, in Appl. Math. Sci. Vol. 157, Springer Verlag, NY 2004, incorporated herein by reference). There is a need for a cubical method that parallels simplicial alpha shape technique as well as the persistence algorithm.

Scanned objects are normally treated by means of the simplicial approach because the scanning process naturally produces a point cloud. However, consider the following. On the one hand, scanning a molecule produces a disconnected point cloud because the distances between atoms are far larger than the resolution of the scanner. On the other hand, a point cloud produced by scanning an object may be thought of as connected because the distances between the points detected on its surface are roughly equal to the resolution of the scanner. Therefore, the object, or its surface, can and should be justifiably represented as a connected collection of points on the grid (pixels or voxels), i.e., a digital image.

There are algorithms of finding explicit representations of generators of the homology of simplicial, cubical, and cell complexes. The standard way is via the Smith normal form. “Computing Homology Groups of Simplicial Complexes in R³” by T. K. Dey and S. Guha, in the Journal of the ACM, vol.45 (1998), pp.266-287, provides an efficient algorithm for simplicial complexes in 3D. But, unlike that of “An Incremental Algorithm For Betti Numbers Of Simplicial Complexes On The 3-Sphere”, Supra, these algorithms are not incremental. As a result, they cannot be easily extended to include computation of persistence and, in general, the homology of dynamical images.

Images as Graphs v. Images as Subsets of the Euclidean Space.

Both cubical and simplicial representations have advantages over another traditional approach to imaging—through representation of images as graphs (“digital topology”). The topology on these graphs is defined via the adjacency relation between nodes. There are several ways to define adjacency: each pixel in 2D has 4 or 8 adjacent pixels, each voxel in 3D has 6, 18, or 26 adjacent voxels, etc. As a result, there is no single method that works equally well in all situations and all dimensions. The evaluation of the global topology of the image, i.e., the homology groups, is very cumbersome in this setting.

An example arises in simplification. During simplification, some topological feature may have to be removed from a 3D binary image. Obvious approaches exist for removal of components and voids. Closing tunnels is a challenge. Methods in the context of digital topology are suggested in “A 3d-Hole Closing Algorithm” by Z. Aktouf, G. Bertrand, and L. Perroton in Lectures Notes in Computer Science, Vol. 1176, pp. 36-47, Springer Verlag, 1996 and “Computing And Analysing Convex Deficiencies To Characterise 3d Complex Objects” by C. Arcelli, G. Sanniti di Baja, and S. Svensson in Image and Vision Computing, 23(2):203-211, February 2005. In either article, homology groups are not computed. In the former article, the fundamental group is indirectly used. The latter article uses components of the complement of the object in its convex hull to represent its tunnels. This approach typically does not produce meaningful results in more complex settings such as that of a porous material.

The approach to imaging via digital topology also leads to conflicts with some of our perceptions about space; for example, the interior of a simple closed curve could be disconnected in digital topology. The reason is that digital topology rejects the natural choice of topology for the image, i.e., the Euclidean topology. This choice is preferable as a practical matter because the image is a reflection of the natural world as we see it. Because of this reason, the natural sciences and mathematics have been developing under the assumption that the world is (locally) Euclidean. In particular, digital topology does not allow the use of the well-developed mathematics (e.g., calculus) without change. For example, there is a need for new definitions of such simple concepts as line, curve, surface, slope, connectedness, etc. A cell complex, while made of discrete pieces, is faithful to the Euclidean nature of the image. As a result, the cell complex representation of images can easily apply, and operate in conjunction with, existing science.

This advantage is also shared by other tessellations, when the space is subdivided into the union of (preferably) identical parts. In comparison, representing objects analytically as smooth functions leads to the need for extrapolation, approximation, and other consequences.

Some problems do not require cell representations, for example, segmentation of binary images. The techniques for this are well known. For example, in U.S. Pat. No. 5,787,194 titled “System And Method For Image Processing Using Segmentation Of Images And Classification And Merging Of Image Segments Using A Cost Function” by Eyal Yair, a scheme of indexing components of a still binary image is provided. Some of its drawbacks are the following: (1) “Runs” of pixels in each row are used. As a result, several regions are merged simultaneously, opposite to two at a time if one pixel is added at a time as in the present method. (2) Reindexing of multiple regions is necessary at each merge, which is very time consuming. (3) There is no splitting of regions as this only applies to still images. However, the main difference is that cell representation of a rectangular grid does not include only the pixels but also edges and vertices. This approach provides a natural description of how the cells are attached to each other, i.e., the local topology.

Representations of images by cell complexes have been used in the past. One example is shown in U.S. Pat. No. 5,694,534 titled “Apparatus Storing A Presentation Of Topological Structures And Methods Of Building And Searching The Representation” to White, Jr., et al. U.S. Pat. No. 5,751,852 titled “Image Structure Map Data Structure For Spatially Indexing An Image” to Marimont, et al. suggests an image data structure that captures hierarchically the local topology of the image at different resolutions and scales. However, neither system allows for computation of the global topological structure, i.e., the homology groups. They are also limited to 2D images.

Some traditional methods treat images as subsets of the Euclidean spaces without representing them as unions of discrete pieces. Instead, the sets are represented by their boundaries which are normally given by continuous functions. These methods may be called continuous. They allow the use of well-developed advanced mathematics, especially PDEs. However, there are drawbacks.

Drawbacks of Continuous Methods.

In image analysis, the main goal is to detect the objects in the image. This process is called segmentation. A crucial step in image segmentation is finding the boundaries of the objects. The process is called edge search. Since the image is represented by a gray level or density function, normally, edges are found by locating the areas of “high” gradient of that function. The choice of how “high” is often beyond control of the user and, therefore, introduces arbitrariness and loss of information to this search. Even if this choice is made by the user, this method still discovers only the areas where the change from black to white is the fastest. However, the areas where the change is slow may be just as important. Ignoring these areas discards parts of the boundaries of the sublevel sets, i.e., sets with gray level below a given threshold, even though they are the most likely candidates for objects in the picture. These sequences of “edges” often have breaks. As result, they are not cyclic and, therefore, cannot be a boundary. A way to overcome this problem is provided by the active contours method. However, this method typically requires a priori knowledge of the topology of the expected segmentation.

Thus, there is a need for a topologically faithful decomposition of the image. In 2D, this means partitioning each frame of a gray scale image into a collection of connected black and white regions separated by their boundaries as cyclic sequences of edges with no gaps. In 3D, the boundaries are surfaces made of squares. Such a decomposition allows a user-controlled simplification as well as feature extraction.

Another feature of these methods is the use of floating point arithmetic. Its drawbacks in comparison to integer arithmetic are well known. The former takes more memory and results in slower computations. It also introduces round-up errors. The significance of these errors, as well as that of the errors resulting from approximations and discretization of continuous methods, is often ignored. These errors may produce instability which may be fatal, especially in an iteration procedure such as in the active contours method. The proof that the error will not affect the output of the method is frequently absent. In fact, there are examples of errors producing unacceptable consequences. The validity of methods that involve PDEs is proven only under restrictive conditions. Most of the time this proof is empirical, not mathematical.

Contour Trees.

A representation of level sets (sets of pixels with same gray level) of an image is given by its Contour Tree in “Computing Contour Trees in All Dimensions” by H. Carr, J. Snoeyink, and U. Axen, in Computational Geometry, 2003, and “Simplifying Flexible Isosurfaces Using Local Geometric Measures” by H. Carr, J. Snoeyink, and M. van de Panne in IEEE Visualization 2004. Contours are the connected components of the level sets. The drawbacks of this approach and the differences from the present method are the following.

The Contour Tree method deals with sets defined in a very specific way as level sets of a function; therefore, they are curves in 2D and surfaces in 3D. If this is a discrete function, it is necessary to deal with the choice of interpolation and the boundary effects. Another problem is that one has to ensure that the critical points of the function are non-degenerate. This is crucial in Morse theory, which is the theoretical foundation of this approach. Morse theory, however, works best with smooth functions. Therefore, functions representing noisy images may have to be smoothed which leads to blurring, flat areas, unspecified effect of approximation, etc.

As the gray level increases, the level sets can split and merge; this information is recorded in the Contour Tree. In one version, each vertex represents a component of the level set of the function. By adding leaves, one records the nesting relationship of these components. In another version, leaves represent components and vertices represent “events” (merge/split). The tree itself does not track all the changes in the topology of level sets (such as a circle turning into a point). It is done by computing the Betti numbers. Therefore, topology is only measured but the features are not extracted. A graph representation of a 3D binary image based on 6-adjacency of voxels is suggested in “The Generalized Spherical Homeomorphism Theorem For Digital Images” by L. Abrams, D. E. Fishkind, and C. E. Priebe, in the IEEE Trans. Med. Imag., 23 (2004), pp. 655-657. Its use, however, is restricted to estimation of Betti numbers.

The simplification of the Contour Tree based on the value of the function discussed in “Simplifying Flexible Isosurfaces Using Local Geometric Measures”, Supra, is proven equivalent to a persistence-based simplification.

Method of Connected Operators.

Connected operators (See “Flat Zones Filtering, Connected Operators, And Filters By Reconstruction” by P. Salembier and J. Serra, in the IEEE Transactions on Image Processing, vol. 4, n. 8, August, 1995, pp. 1153-1160) are useful in simplification of binary and gray scale images. Generally, these operators are defined as ones that make partitions of an image less fine. In applications, these operators remove regions in binary images and merge level sets in a gray scale images. Theoretically, any region in the image can be removed by means of this method. However, for the purposes of simplification, the choice should be based on the importance of the region to be removed. The measure of importance is determined separately and could be the area of the region or, in case of gray scale images, its contrast. The assumption is that objects with low area or low contrast are unimportant and should be removed to obtain a simplified image.

The method of connected operators applied to simplification and segmentation has some advantages over continuous methods. The boundaries remain unchanged. In case of a gray scale image, the contours are preserved. Therefore, unlike most continuous methods, the edges of the objects do not become blurred. The method provides a partition of the image that is topologically faithful in the sense that there is no change in the connectivity of the regions in comparison to the original unless required by the user. This is possible because the method does not lose information, as there is no approximation involved.

However, this method is inadequate for image simplification in higher dimensional situations. Specifically, the removal of features in the intermediate dimensions, between 0 and the dimension of the image, cannot be properly addressed. An example is the hole of a donut as a 1-dimensional feature of a 3-dimensional object. This hole cannot be removed by this method because it does not correspond to any region. Such a topological feature can only be properly described and dealt with in the context of homology theory.

Another disadvantage of this method is that it concentrates on the boundaries of the objects (level sets) instead of the objects themselves (sublevel sets).

Level Sets v. Sublevel Sets.

The goal of segmentation is to find objects in the image. The above methods segment the gray scale image by finding the level sets. Then it is assumed that these sets are boundaries of the objects in the image. Therefore, an object is a sublevel set, i.e., a collection of pixels with gray level below some threshold.

As an alternative, the sublevel sets are used to represent objects. Of course, level sets may still be necessary for visualization or other applications. However, once objects are found, finding their boundaries is an easy task. A pixel or voxel belongs to the boundary if it is adjacent to both the set and its complement. In fact, finding an explicit representation of the set based on the knowledge of its boundary is much more challenging. In fact, approximations in the edge search in 3D often lead to surfaces that are not “airtight”; therefore, they don't bound any volume.

The sublevel approach has certain advantages. The biggest is that the sublevel sets of a function are more robust with respect to the errors of the gray level function. Thus, if a discrete function is created from a smooth function, the sublevel sets of the latter better reflect those of the former than the level sets.

Other advantages lie in the area of image simplification. Simplification requires the removal of some connected components based on their importance. An object is important, and not to be removed, when it is large in size. Thus, in a gray scale image, objects should be removed based on their sizes not sizes of their boundaries. The proper measure of size of an object in 2D is its area, not its perimeter. In 3D it is its volume, not its surface area. Treating objects as surfaces also forces to interpret 1-cycles as “handles” of the surface. This interpretation fails in more complex settings such as that of a porous material.

Thus, this is the issue of the volumetric representation of an object v. the surface representation.

Digital Morse Theory.

“Digital Morse Theory for Scalar Volume Data” by J. Cox, D. Karron, and N. Ferdous, in the Journal of Mathematical Imaging and Vision, Vol. 18, 2003, pp. 95-117, provides an algorithm for the study of the sublevel sets. The results are recorded in the “criticality tree”. Its nodes correspond to the values for which the topology of the sublevel sets changes. Objects are the connected components of the sublevel sets.

The method uses Morse theory. Even though it is a modified, discrete version, it still has to deal with problems of general position and discretization of continuous methods. Even more importantly, the setting of Morse theory sets some limits on the scope of imaging problems that can be addressed. Indeed, this theory is designed to detect changes in topology of the sublevel sets of a function. The threshold value of this function serves as the parameter associated with the image. As this parameter grows the topology of the sublevel sets changes. In fact, these sets must grow when the parameter grows. Therefore, sublevel sets may merge and handles may appear but sublevel sets never split and handles never break.

Thus, the nature of this setting makes it inapplicable in the following important areas. First, there can be no multiple parameters, as in color images, as Morse theory deals with a single function. Second, time cannot be a parameter as the topology may change arbitrarily with time. Third, the method does not allow explicit representation of topological features, especially in the intermediate dimensions. These drawbacks are shared by other similar approaches, such as the “tree of shapes” as shown in “The Tree Of Shapes Of An Image” by C. Ballester, V. Caselles, and P. Monasse, in ESAIM: Control, Optimization and Calculus of Variations, January 2003, Vol. 9, pp. 1-18.

Local v. Global Processing.

Currently, in most of image processing, as in the case of image enhancement and simplification, procedures are global. This means that a change of one part of the image will affect the processing of other parts.

An example of such a method is the Fourier transform as its computation involves summation over all pixels of the image. Suppose the image undergoes the usual procedure: Fourier transform-filter-inverse Fourier transform. The outcome is an enhanced image. Now suppose that a part of the image has been significantly degraded (or even missing). Then the above procedure may have dramatically different results even for the unaffected parts. This outcome is also inevitable in histogram modification methods.

Depending on the size of the window, filters may be considered local. In particular, the most elementary morphological operations such as dilation (thickening) and erosion (thinning) are local. However, these operations provide little control over how, what, and how much is removed from or added to the image.

The methods of algebraic topology are local as they deal with vertices, edges, faces, etc, and the ways they are attached to each other. On the other hand, these methods detect global features of the object, such as components, tunnels, voids, etc. Therefore, the degradation of a part of the image will not affect the processing of other parts unless some global features have been degraded as well.

User's Control Over Image Enhancement And Simplification.

The word “partition” means decomposition with no overlap. We use this word instead to the more common “image segmentation” because the latter does not have a standard or well defined meaning. “Image segmentation” also usually includes prior image simplification and “denoising”. Normally, both require a priori information about the image and the nature of the noise. Therefore, these techniques cannot be safely applied outside of their original scope. In particular, denoising methods are content dependent because the nature of noise in photography, fingerprinting, or electron microscopy is different.

Currently the goal of image processing software is to “enhance” the image and simply give the new image to the user. But how can one make sure that something important has not been lost during the “enhancement” ? The only way is to compare visually the new (“good”) image to the original (“bad”) one. The same problem exists in the context of image compression. Further, both “smoothing” and all thresholding techniques introduce arbitrariness to the process of simplification. Meanwhile, unspecified changes to the original are unacceptable in many settings. For example, in science the removal of an “insignificant” feature from the image without approval by the researcher can lead to a missed discovery. In medicine, such a practice may lead to a misdiagnosis. In forensic imaging, the enhanced image may be challenged in court. In photography, the user has to deal with aftereffects of enhancements, such as halos, blur, etc. Therefore, there is a need for an automatic system that allows total control by the user over what and how much is removed from the image.

Consider the example of a gray scale image. Information is lost when one chooses a particular threshold, which is a common way of simplification, segmentation, as well as motion tracking. Even though the thresholds are often chosen based on the shape of the histogram and other information to make it best, sometimes no single choice of a threshold will reveal all the features. This is the case when one part of the picture is significantly darker than another, as is common in fingerprinting. Here is a simple specific example: a black object on gray background next to a gray object on white background. No matter what threshold is chosen, there is only one object visible. A similar example with 255 objects of different levels of gray on lighter backgrounds would show that any method based on merging gray levels, including hysteresis, will fail to distinguish all of these objects.

From the point of view of a consumer, there is also a need for a simple yet user-controlled image simplification (also called enhancement, denoising, etc) system. Even in a scientific setting, the user is often unfamiliar with either imaging terminology, such as filtering, snakes, dilation, erosion, etc, or advanced mathematics involved, such as wavelets, Fourier transform, or PDEs. When this is the case, the user is forced to accept the results provided by the software and rely entirely on visual inspection and subjective judgment. There is a need for an image simplification system so elementary that even a user with no background in imaging or mathematics will be able to understand exactly what is happening and control the outcome.

Processing of Video Sequences.

The changes of topology of the frames of a video sequence cannot be captured by a Contour Tree. Because of the nature of this setting, the changes to the topology of the sets bounded by the level sets (sublevel sets) are not as general as in the case of a dynamical image, such as a movie. For instance, the components of the sublevel sets never merge (or never split, depending on the order of the levels).

A time-dependent Contour Tree, as shown in “Time-Varying Contour Topology” by B.-S. Sohn and C. Bajaj, in the IEEE Transactions on Visualization and Computer Graphics, January/February 2006, pp. 14-25, is created as follows. First, the topology of each frame is precomputed in the form of its Contour Tree and its Betti numbers. Then the Contour Trees of the frames are connected to each other by following a rule based on detecting intersections of the components. Therefore, other changes in topology, such as appearance and disappearance of handles, are not recorded.

This problem is addressed in “Time-Varying Reeb Graphs For Continuous Space-Time Data” by H. Edelsbrunner, J. Harer, A. Mascarenhas and V. Pascucci, in the “Proc. 20th Ann. Sympos. Comput. Geom., 2004”, pp. 366-372. by means of time-varying Reeb graphs. However, these graphs record the changes of the topology of the level sets, not sublevel sets, of a smooth, not discrete, time-dependent function. Also, this approach only detects the changes in the topology but does not explicitly record them in terms of appearing, disappearing, merging, and splitting of the generators of the homology groups.

Thus, there is a need for a system that analyses the topology of time-dependent images.

### BRIEF SUMMARY OF THE INVENTION

In view of the limitations of the present art in the area of image processing, the present invention provides a new, unified method of partition and simplification of 2D, 3D and higher dimensional images, gray scale, color and multichannel, movies, and images created from point clouds. The new method is simpler, faster, more robust, more versatile, easier to customize, content independent, and has broader applications than known methods. Unlike most of the prior art, it is designed to be consistent with the mathematical theory of imaging, i.e., topology/geometry.

The primary objective of the present invention is to provide a method that makes the techniques of algebraic topology applicable to, first, gray scale and color images and, second, sequences of images. Only this will make these techniques practical and useful in imaging.

Generally, the method finds explicit representations of the topological features of multi-dimensional multi-parameter images. Unlike most of the prior art, the method is based on volumetric representation of images.

### BRIEF DESCRIPTION OF THE DRAWINGS

FIG. 1A is an example a gray scale image, the original, and FIG 1B is the result of denoising the image in FIG. 1A;

FIGS. 2A, 2B, 2C, and 2D together are an example of the removal of features from a gray scale image based on size. The largest area of the features removed for FIGS. 2A-2D are 0 (the original), 100, 300, 500 pixels, respectively;

FIGS. 3A and 3B together are an example of the removal of features from a gray scale image based on different measurements. FIG. 3A is the original and FIG. 3B is the image with all the features with area/perimeter<0.5 removed;

FIGS. 4A, 4B, 4C, and 4D together are an example of the removal of features from a gray scale image based on contrast. The contrast of the features removed for FIGS. 4A-4D are less than 5, 50, 75, 127 (binarization), respectively;

FIGS. 5A and 5B together are an example of compression. FIG. 5A has 256 gray levels, while FIG. 5B has 4;

FIGS. 6A and 6B together are an example of a processed image. FIG. 6A is the original image and FIG. 6B is the collection of cycles;

FIGS. 7A and 7B together are an example of curve reconstruction. FIG. 7A is a point cloud and FIG. 7B is the curve it represents;

FIG. 8 is a block diagram that illustrates how an edge being added connects two different 0-cycles and how an edge being removed is a part of a 0-cycle;

FIG. 9 is a block diagram that illustrates how an edge being added connects a 0-cycle to itself and how an edge being removed is a part of a 0-cycle and a part of a 1-cycle;

FIG. 10 is a block diagram that illustrates how an edge being added connects a 1-cycle to itself and how an edge being removed is a part of two 1-cycles;

FIG. 11 is a flowchart illustrating processing of frame F of the dynamical image with constrains on the Betti numbers;

FIG. 12 is a flowchart illustrating adding k-cell C to frame F;

FIG. 13 is a flowchart illustrating removing k-cell C from frame F;

FIG. 14 is a flowchart illustrating creating a subcomplex with Betti numbers within range from subcomplex K;

FIG. 15 is a flowchart illustrating morphing subcomplex K of complex M toward subcomplex T within range of Betti numbers; and

FIG. 16 is a block diagram illustrating a General Purpose Computer.

### DETAILED DESCRIPTION OF THE INVENTION

First Embodiment.

Applications of Dynamical Images.

By a dynamical image, in the first embodiment we understand a sequence of 2D binary (black-and-white) images or 0-and-1 arrays of the same size, which we call frames. Dynamical images can also be called image sequences. The change from a frame to the next is treated as a result of the change of the parameter of the image which is simply the number of the frame. Each homology class of each frame is traced to the next frame and its lifespan is the collection of all frames of the dynamical image that contain this homology class.

Some examples of dynamical images are the following: (1) Black-and-white movies, where the parameter is time. A dynamical image is also obtained from a still binary image by moving a frame around the image, zooming in/out, tilting, etc, or drawing on it. (2) Gray-scale images, where the parameter is the gray level. Given a threshold T, the corresponding frame contains all the pixels with gray level lower than or equal to T. More generally, the parameter may be any numerical value (pressure, temperature, density, etc). (3) Binary 3D images, where the parameter is the number of the slice of the image. Given a cross-section of the image, the corresponding frame contains all the pixels in this slice. (4) A black-and-white image (and especially a point cloud) modified by multiple applications of morphological operations, where the parameter is the step number in the process. The most typical operation is that of dilation (thickening). Combinations of all four are possible.

An object of the present invention is an improved and unified way to partition and simplify dynamical images. The present embodiment of the method is for a 2D rectilinear grid. However, its applicability to unstructured meshes and simplicial complexes is obvious to a person skilled in current art. A multi-dimensional multi-parameter embodiment is also provided.

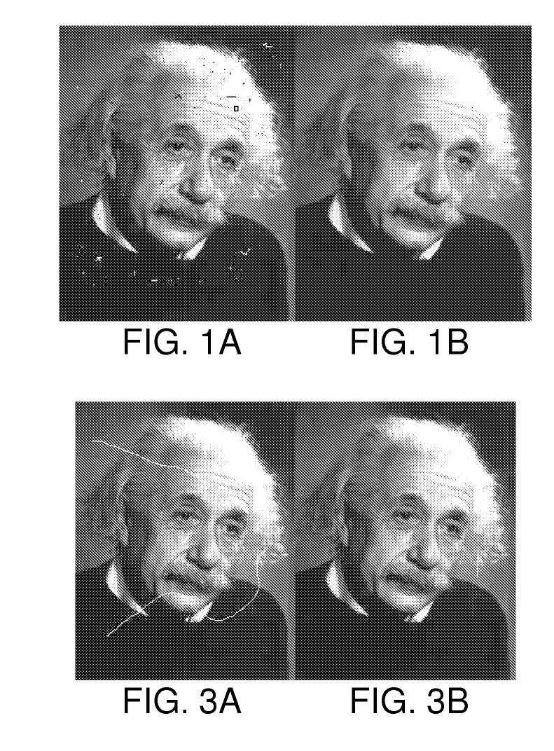

In each of the four application areas presented above, the outcome of the algorithm is the following: (1) Detection, tracking of objects in a movie, or a radar screen, denoising, counting (the change of) the number of objects depending on their size or lifespan, computing the velocities of the objects or that of the camera. (2) Partition of a gray scale (or color) image, extraction of features, as well as simplification—removing insignificant features and noise (FIG. 1), according to user's settings of the parameters. (3) Partition and simplification of binary 3D images. (4) Cubical complex representation, in addition to triangulation, of point clouds, detection of large features, as well as simplification. For all four, computation of topological characteristics of both the original and the simplified image.

The Approach to Partition of a Dynamical Image.

The method consists of four primary parts: (1) the creation of a dynamical image from a still image (in case of a movie it already exists), (2) the partition algorithm, (3) simplification, and (4) visualization.

Each frame is partitioned into a collection of regions: connected sets of black pixels and connected sets of white pixels. The partition is achieved by finding boundaries of regions as closed curves made of vertical and horizontal edges of pixels. These sets are constructed through an incremental process as pixels, one by one, are added to and removed from the current frame to transform it into the next frame. More precisely, we follow the cubical complex representation of binary images—the pixels are squares which in addition have edges and vertices.

The information is recorded in a graph. As the new edge appears, it either connects two components or creates a hole in a component. In the former case, the edges with pointers to these components are made to point to this new component. In the latter case, a node is created and the edge has a pointer to this node. In both cases, there is a pointer from the node to one of the edges. This pointer provides a starting point for the boundary search, which is sufficient to recover the cycle explicitly whenever necessary. Thus, neither components nor their boundaries are typically recorded.

The data structure for the image is preferably an acyclic binary directed graph. For each frame, the regions and holes in them are represented as nodes of this graph. Each node representing a region or hole is connected to the nodes representing regions and holes that existed previously (parents) or appear later (children) by directed edges, or arrows, of the graph. The arrows (typically one or two from each node) indicate merging and splitting of the regions as we add or remove pixels. This allows one to find the current component of a given pixel (or vertex, or edge). This is done by following the pointer from the edge to its original node and then following the links of the graph to find the current node. This approach allows one to avoid reindexing of components after they merge. As another benefit of this approach, only the boundary of one of the components emerging after a split is reindexed (see below). There are no circular sequences of links.

The more important part of this graph consists of the connections of regions in the current frame to the ones in the next. These links reflect merging and splitting of the regions as we move from frame to frame.

Improvements Over the Alpha-Shapes Method.

First, preferably, only integer arithmetic is employed in this invention. In comparison to floating point arithmetic, this increases speed, reduces memory requirements, and protects from consequences of possible propagation of error through repeated floating point calculations. Also, the preferred data structure is a binary graph, which is simpler than what is appropriate in the simplicial approach, where adding a single edge (several may appear simultaneously) often creates a multitude of cycles. The present method also avoids the time-consuming task of triangulation of the alpha-complex, as well as its consequences, such as dependence on general position, instability, etc.

The persistence approach to alpha shapes has been generalized but it still applies to only very specific dynamical images (simplicial or cubical). Indeed, the persistence algorithm only works with filtrations, i.e., growing complexes, so that vertices, edges, and faces are being added and never removed. The present method extends these techniques to include arbitrary dynamical processes so that vertices, edges, and faces can both appear and disappear.

Further, in the present method the persistence of a feature is understood and used much more broadly. Previously, it is its:
lifespan=index of death−index of birth,
where the index is the number of steps (i.e., added simplices) since the algorithm started. Alternatively, and more appropriately,
Persistence of a Feature=Its lifespan=Frame of Death (D) Frame of Birth (B)
In the current method, the lifespan persistence is applied as follows.

In case of a video, the lifespan of an object or another topological feature is simply how long it stays on the screen. Suppose now a gray scale image produces a dynamical image through thresholding. Then persistence of a (black) object=D−B, where B is the threshold that creates the feature in black surrounded by white and D is the threshold that makes the surrounding area black as well. Therefore, persistence is the contrast of the feature. More precisely, the persistence of a region in a frame is computed as N−B, where N is the number of the frame. The persistence of holes is defined similarly as they are white objects surrounded by black.

However, the persistence as D−B has drawbacks in the context of point clouds. Suppose the first object in the picture is a roughly circular curve of radius 40 made of 10 points 20 units apart. Suppose the second object is a scaled down version of the first, a circle of radius 20 made of 10 points arranged in a circle 10 units apart. Even though these are two equally recognizable features, the bigger one has higher persistence. Indeed, for the first D−B=40−10=30. For the second, D−B=20−5=15. It is clear then that the “relative density” D/B is a better way to measure recognizability of a feature (4 for both circles) when a dilation procedure is involved. Using a measure of the feature that is independent of its size is especially important in imaging, where its size relative to the size of the image may be unknown. The size of the feature can still be taken into account. It is obtained by a direct measurement once the feature has been extracted or by using line integration discussed in the next section. In general, the lifespan persistence of a feature is an appropriate combination of B and D (or B and N) that can be chosen by the user.

Another important difference of the current embodiment is the use of cubical complexes (instead of simplicial), more appropriate for image analysis. While simplicial complexes are less suitable in image analysis than cubical complexes, the latter can be adopted for analysis of point clouds. In fact, the “alpha shapes” approach to point cloud problems can be recast in terms of cubical complexes. For example, a point cloud data of a molecule can be reduced to a 3D gray scale digital image by assigning to each voxel the average distance to each of the atoms. The justification for this approach is that the alpha-complex of a point cloud can be continuously transformed into the union of balls with the same alpha, i.e., they are homotopy equivalent. In particular, Betti numbers are the same. The method applies more generally to “cell complexes”.

The Approach to Simplification of a Dynamical Image.

The approach to simplification is as follows. The user is given an option to remove from the image the features the characteristics of which lie within the limits chosen by him. Meanwhile, if all the limits are set to zero, visualization of the output produces the original image.

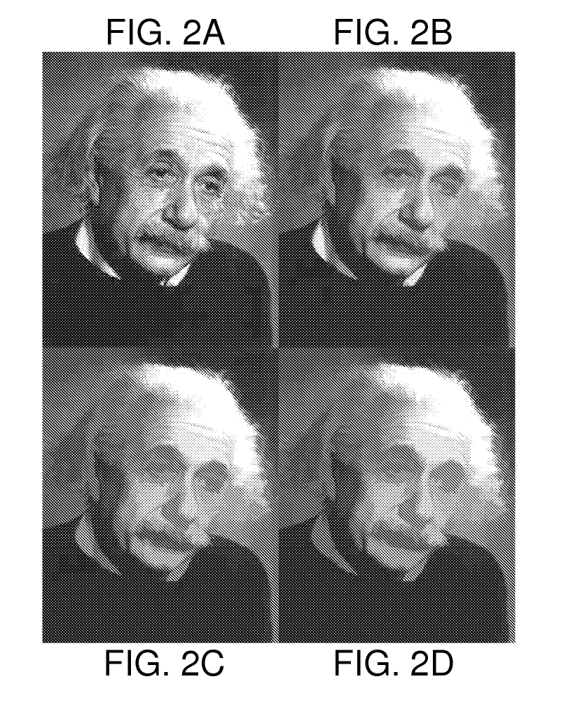

The size-based simplification means removal of features of “small” size. Since a feature is represented by a cycle as a sequence of edges, by “size”, we understand the area of the interior of the cycle. Then small black and/or small white regions are removed. More generally, the size can be the integral of any continuous function of two variables over this region or a line integral along the cycle representing the region. These characteristics are updated at every step of the algorithm and recorded in the nodes of the graph. From the current frame, a feature is removed if its size is less than a given level (FIGS. 2A, 2B, 2C, and 2D).

Several different kinds of “sizes” may be used simultaneously. For example, to remove a scratch from a photograph choose: area/perimiter <0.5 (FIGS. 3A and 3B). Similar settings would also help to identify and extract roads from high resolution satellite images or ridges from noisy fingerprint images.

Other characteristics of the objects can be computed as line integrals. Those include but are not limited to perimeters, moments (and, therefore, centroids), curvatures, etc.

Consider now the lifespan-based simplification. Generally, the features are removed if their lifespans are below a given setting or threshold. In case of a video, this means that if a feature does not stay on screen long enough (such as noise), it is removed.

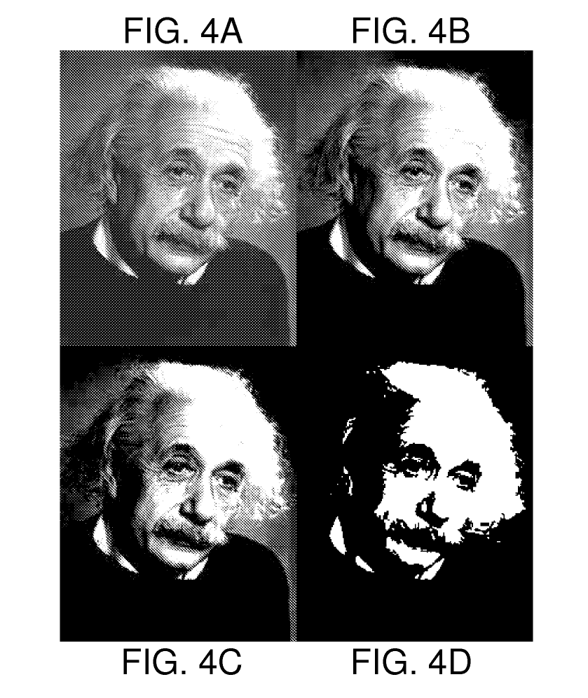

For a gray-scale image, the lifespan of a feature is its contrast. Therefore, the result of the lifespan-based simplification is that the features with the contrast below a given threshold T are removed (FIGS. 4A, 4B, 4C, and 4D). It is especially important that features of high contrast are preserved and features of low contrast are removed regardless of their gray levels. To visualize the simplified image, the gray levels of pixels can be reassigned. A natural choice is the following piecewise linear function. If the gray level L is less than T it is replaced with 0 (black), if L is greater than 255−T it is replaced with 255 (white), for the rest L is replaced with 255(L−T)/(255−2T). A special kind of binarization (black-and-white picture) of the image is achieved for T=127. The choice of T and the recoloring function can be optimized by taking into account the histogram of the image.

In case of a 3D binary image, lifespan-based simplification removes “thin” features. A better way to simplify it is to remove 3D objects of low volume.

In case of a thickened point cloud, incidental holes are removed.

The crucial difference between these two types of simplification is that the lifespan of a feature consists of several frames while a size is computed within one frame. However, mixed simplification criteria are also possible. For example, the sum of the sizes in each frame captures the significance of the feature in a single number.

The present approach to simplification is different from the one shown in “Topological Persistence And Simplification” by H. Edelsbrunner, D. Letscher, and A. Zomorodian, in Discrete Comput. Geom. 28 (2002), pp. 511-533, where it means reordering the filtration.

The Output of the Algorithm.

The first part of the output of the algorithm is a collection of cycles representing the boundaries of objects in the image (FIGS. 6A and 6B). These cycles can be applied as follows. (1) The cycles can be plotted in black to reveal boundaries of a gray-scale image. This creates a black-and-white “drawing”. (2) If they are filled with an appropriate choice of colors, the user can view a new, simplified, image. The image may be denoised, or the contrast increased/decreased. (3) The interiors of the cycles can be recolored based on their size. This is crucial to some photography tasks that require smaller features to stand out or in delivering TV programming to people with impaired vision. (4) In a movie, a given cycle and all its descendents can be plotted in the same color throughout all frames to help track an object. (5) For a 3D binary image, if the cycles in each frame are plotted in the corresponding level in 3D, they render the surface boundaries of the components of the image. (6) The cycles can be used for further, possibly manual, editing by the user. For example, they can be moved around or deformed. (7) Besides visualization, the boundaries can be extracted and used elsewhere. For example, they can be matched with cycles collected from another image, or used for picture enlargement, or separation of foreground from background.

Another part of the output is the sequence of pairs of Betti numbers, B₀, B₁, as they change from frame to frame. Their change reveals the change in the topology of the image (merging and splitting of components, appearance and disappearance of holes, etc). In case of a video, the user can detect an important change and choose to look closer at the frame where it happened. The Betti numbers do not reveal the full information about the topology of the image, but they can be used for a fast search in an image database.

The other side of image simplification is feature extraction. If objects, such as a cancer tumor, blood cells, can be quantitatively described, the algorithm will isolate them from the rest of the image. As in the prior art, the objects can be extracted as regions or contours. In addition, they can be extracted as gray scale images.

For the purposes of segmentation or motion tracking, the components may be combined into “objects” based on similarities in terms of color, texture, proximity, velocity, etc.

All techniques of digital imaging can be used as preprocessing or postprocessing for the present method. For example, when there is a priori knowledge about the noise, starting with denoising will improve the performance of the present method.

Topologically Constrained Simplification.

The partition algorithm is carried out along with the computation of topological characteristics, Betti numbers. This makes possible an additional feature of topology preservation. As the dynamical image develops, it is partitioned and simplified. Now, as a part of the algorithm, the current topology settings can be protected in the sense that adding or removing pixels is not allowed to change the topology of the image. This is done by keeping the Betti numbers constant. In general, Betti numbers do not capture all the information about the topology of the complex. It is impossible, however, to change its topology by adding or removing a cell (or a pixel) without changing the Betti numbers.

The topology can be preserved entirely or to the extent set by the user. Suppose the algorithm detects a dramatic change in the topology of the image, such as merging of two large components. Then it cancels the change by rejecting the pixel that is supposed to be added. In case of splitting of a component into two large ones, the topology is preserved by keeping the pixel that is supposed to be removed. In other words, the change of topology is immediately undone (AddCell followed by RemoveCell or vice versa, below). In this particular example, it suffices to preserve the 0^{th} Betti numbers (B₀). On the other hand, by preserving only 1^{st} Betti numbers (B₁), the user can allow merging and splitting of components but prohibit the emergence or disappearance of holes.

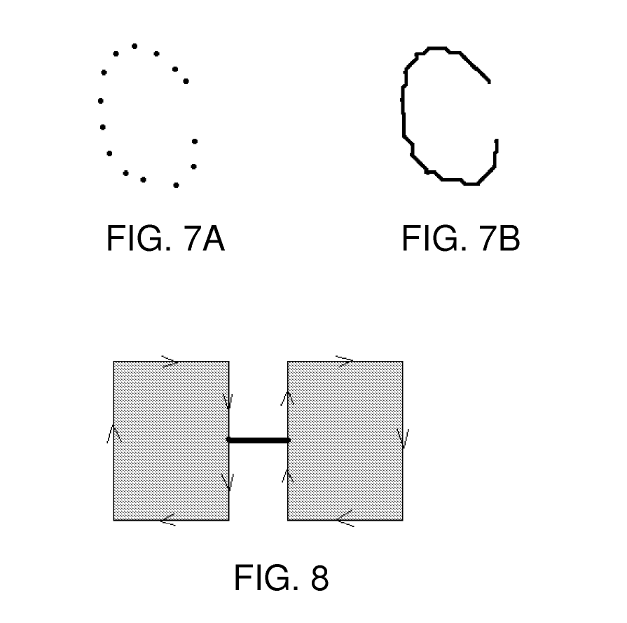

This option makes possible a simple alternative to the standard techniques of curve (or surface) reconstruction by means of alpha shapes. Suppose we have a point cloud as a collection of pixels on the rectangular grid. Instead of blowing up disks or balls around each of the points and then constructing a triangulation as an alpha-complex, we use the following dynamical image. In the first stage, it develops through dilation, i.e., making black each pixel (4- or 8-) adjacent to a black pixel. The process stops when we have a connected region (B₀=1). In the next stage, the dynamical image develops through a topology preserving erosion, i.e., making white each pixel adjacent to a white pixel, with additional restriction that the original points remain black. The process stops when there is no more change. In the last frame, we have a collection of curves one pixel thick (FIGS. 7A and 7B). The partition algorithm performed with this dynamical image produces a cubical complex that is homotopy equivalent, up to the simplification, to the alpha-complex. It is created, however, without the use of triangulation or floating-point arithmetic. Thus, the present method incorporates a way to overcome the major drawback of the grid imaging in comparison to the simplicial approach-structured data acquisition and recording. For a gray scale image, this procedure is carried out for each gray level.

In these examples, either the inner or outer boundary of the resulting object is a true curve (made of edges of pixels) in 2D or surface (made of faces of voxels) in 3D. Another way to obtain a true curve or surface is to have the above algorithm reject not only pixels but also faces and edges.

The Data Structure of the Algorithm.

This algorithm partitions a 2D dynamical image by providing boundaries of the objects in each frame of the image. Geometrically, these boundaries are typically circular sequences of directed edges of pixels in the image. In this algorithm, they are preferably represented by nodes in a directed graph. In this graph, the boundaries are related to each other to record the changes in the topology of the image in terms of merging and splitting of components and holes as the image develops from frame to frame. In particular, the 0- and 1-Betti numbers (B₀ and B₁) are updated at every step.

Three Boolean arrays of the same size are preferably used: previous frame (P), current frame (C), and next frame (N). P and N are frames of the dynamical image; C is the current state of the image as it develops pixel by pixel from P to N.

Edges form cycles kept in a directed graph. The cycles found in C are called “current”. The cycles in N that remain after simplification are called “active”.

Each node of the graph preferably contains only two pairs of links (pointers) to previous and next nodes. If the cycle is merged with another, there is one link, if it splits, two. There is also a pointer to the “info node” containing: the dimension of the node, the frames of birth and time of death, a pointer to the edge that created the cycle, the area, the other integrals, etc. This node can be deleted when the cycle ceases to be current, i.e., after a merge or a split. For the sake of fast visualization of the active cycles, the pointer to the next active node is also maintained.

The list of all edges is maintained so that all current edges have pointers to nodes of the graph. Since 0-cycles are components and 1-cycles are holes in them, one can think of 0-cycles and 1-cycles as black and white components, respectively. Both types are captured by a pointer to one of the edges in its boundary. Given the current image, a current cycle can be traversed by taking right (left) turns from the initial edge until this edge is reached again. This way the image is always on the right (left). The boundary of a 0-cycle is traversed clockwise and a 1-cycle is traversed counterclockwise, or vice versa.

The Step of the Algorithm.

C transforms over time from P to N as follows. At every step of the run through the image, the pixel in P is compared to the corresponding one in N. If the colors are the same, skip to the next step. If the color changes from white to black, execute “AddCell”. If it changes from black to white, execute “RemoveCell”. Every time the geometry of the image changes, the list of cycles and the graph, the numerical characteristics of the cycles, and the Betti numbers are updated.

The AddCell command first adds one by one each of the 4 vertices of the pixel unless it is already present. AddVertex creates a node of the directed graph. Next AddCell adds one by one each of the 4 edges unless it is already present. AddEdge either creates one node if it is a merge or two nodes if it is a split. The links for these nodes come from the SplitCycle and MergeCycles commands described below. Typically, the last step of AddCell is to add the pixel itself by removing the 1-cycle made of the 4 edges from the graph.

The RemoveCell command first removes the pixel itself by creating a node for the 1-cycle made of its 4 edges. Then it removes each of these 4 edges one by one provided it is not an edge of another pixel. RemoveEdge either creates one node if it is a merge or two nodes if it is a split. The links for these nodes come from the SplitCycle and MergeCycles commands described below. Next, each of the 4 vertices of the pixel is removed unless it is a vertex of another pixel. RemoveVertex removes the corresponding node from the graph.

By removing a node (or a cycle) from the graph we understand either the physical removal from the memory or simply marking it as non-current. Creating a node (or a cycle) means allocating memory for the data.

Next, we describe under what circumstances and how MergeCycles and SplitCycle are executed.

If the edge being added connects two different 0-cycles, they are merged. MergeCycles with these two 0-cycles as the input creates a new 0-cycle. Its birth-frame is that of the older of the parents. The 0-Betti number (B₀) goes down by 1. (FIG. 8)

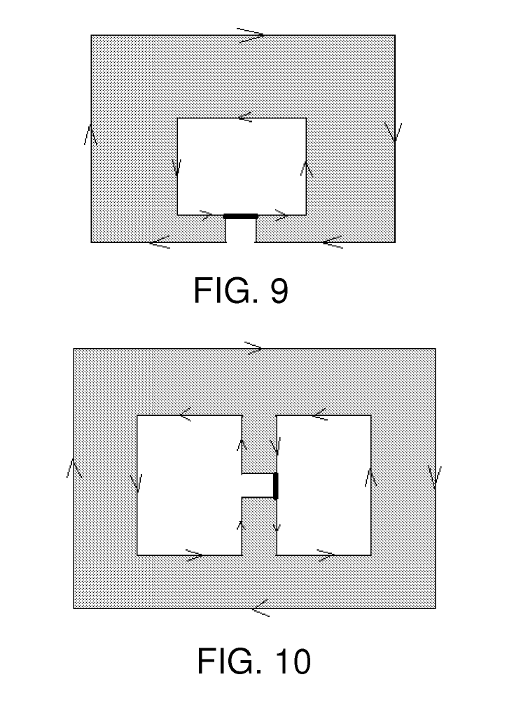

If the edge being added connects a 0-cycle to itself, this cycle is split. SplitCycle with this cycle as the input creates a new 1-cycle and a new 0-cycle. The birth-frame of the former is the current frame and the birth-frame of the latter is that of the father. The 1-Betti number (B₁) goes up by 1. (FIG. 9)

If the edge being added connects a 1-cycle to itself, this cycle is split. SplitCycle with this cycle as the input creates two new 1-cycles. The birth-frames of these are that of the father. The 1-Betti number (B₁) goes up by 1. (FIG. 10)

If the edge being removed is a part of a 0-cycle and a part of a 1-cycle, these cycles are merged. MergeCycles with these cycles as the input creates a new 0-cycle. Its birth-frame is that of the 0-cycle. The 1-Betti number (B₁) goes down by 1. (FIG. 9)

If the edge being removed is only a part of a 0-cycle, the cycle is split. SplitCycle with this cycle as the input creates two new 0-cycles. Their birth-frames are that of the father. The 0-Betti number (B₀) goes up by 1. (FIG. 8)

If the edge being removed is a part of two 1-cycles, the cycles are merged. MergeCycles with these cycles as the input creates a new 1-cycle. Its birth-frame is that of the older of the parents. The 1-Betti number (B₁) goes down by 1. (FIG. 10)

To make the correct choice between MergeCycles and SplitCycle, there should be a quick way to identify the cycle corresponding to a given edge. This look-up procedure is called GetCycleNode. For this purpose, a look-up list is typically maintained. For each edge E, the list contains a pointer to the node that represents the cycle created when E was added (this pointer is NULL if the edge is not current). To make the algorithm faster, this list is preferably only updated by SplitCycle. While traversing one of the created cycles it assigns to the edges the node corresponding to this cycle.

For a given edge, GetCycleNode is carried out as follows. First, use the look-up table to find the cycle node corresponding to the edge. Originally, it is the cycle created when this edge was added, later possibly reassigned by SplitCycle. Therefore, the cycle node may be non-current. Second, starting from this node, follow the links of the directed graph as far as possible. The result is the current node corresponding to the edge. Because this is a binary graph, the search of the current cycle of a given edge is unambiguous. This is assured by following the two rules: (1) in SplitCycle, reassign the edges of the first of the two cycles being created, (2) in GetCycleNode, follow the second link at each split. An alternative data structures appears if SplitCycle (and MergeCycles) rewrites (one of) the original node (nodes) instead of creating a new one.

As cycles merge and split, a new cycle inherits the birth-frame of the (older) parent of the same dimension. However, other schemes may be appropriate depending on the application. For example, the birth-frame of the new node may be the weighted sum of those of the parents with weights equal to their sizes.

Traversing Cycles and Computing Line Integrals.

Traversing the cycle is accomplished by means of repeated application of the StepForward command. From a given directed edge, StepForward moves to the next directed edge that must already be current. The next edge is found by checking which of the four possible next edges is current. This is verified by means of the look-up table. The next edges are preferably tested in this order: from the end of the edge, step right (left), step forward, step left (right), step backward (same edge pointed backward). As a result, one goes around the cycle until the initial edge is reached. Traversing a cycle can also be carried out by simply maintaining a list of cycles as sequences of edges or vertices.

While traversing the cycle, the line integral of a given vector field F along the cycle is computed. We start with 0 at the initial edge. Then, at each consecutive edge E with the initial point at (x,y) we add the following value: the x-component of F(x,y) if E points to the right, the negative of that if E points to the left, or the y-component of F(x,y) if E is points up, the negative of that if E points down.

According to Green's Theorem, the double integral of any function f(x,y) over a region can be reduced to a line integral along its boundary and, therefore, computed this way. In particular, the area of the outer boundary of a component or the inner boundary of a hole can be computed if desired by the user (choose F(x,y)=(0,x)). Another important possibility is the moments of the region as they provide its center of mass. Other integrals have a value as well; for example, we can compute the perimeter of a component (the length of the cycle) or similar characteristics.

Typically, traversing cycles and computations of the integrals are only done during the SplitCycle command and only for the first of the two new cycles. The integral of the second cycle is found as the integral of the parent cycle minus the integral of the first cycle (the integral is “additive”). In case of MergeCycles, the integral over the new cycle is simply the sum of the integrals of the two parent cycles. The new edge does not contribute to the values of these new integrals because it is traversed back and forth.

Simplification.

The output of the algorithm after every frame has been processed is the collection of all current cycles. Next, the Evaluation command either accepts or rejects each cycle. This command rejects the current cycle if its numerical parameters are different from (especially, lower than) the ones set by the user. The remaining cycles and their edges are called “active”. This information is recorded at the node of the cycle. Therefore, GetCycleNode will tell you whether a given edge is active.

First, the current cycles with low area are marked as inactive (or rejected and not recorded into the graph of the simplified image). As described above, more general characteristics are the area integrals of a function f(x,y) over the exterior boundary of the cycle. For the sake of meaningful simplification in photography, the function f(x,y) should preferably be chosen non-negative. This will ensure that the removal of a component would also imply the removal of all of its holes, components located in these holes, etc.

Another important characteristic of a cycle is its lifespan. A component emerges at frame B (birth) and merges with the surrounding area at frame D (death); a hole emerges at frame B and is filled at frame D. The total lifespan is D−B. In the present embodiment, the current lifespan, N−B, where N is the number of the current frame, is used to decide whether the feature should be plotted. In case of video, this is how long the feature has been present on the screen. In case of a gray-scale image, this is the contrast of the feature. In case of a 3D image, it is the thickness of the object. In case of thickening of a point cloud, this is (roughly) the minimal diameter of in the feature minus the largest distance between its points. Other numerical characteristics to be used here have been discussed above.

For simplification of 3D images, the volumes of its features may be needed. A connected component of a 3D image is represented by a connected component of the graph. Nodes in this subgraph represent components and holes in the slices of the component. Therefore, the volume of a component can be computed by adding together all areas recorded in the corresponding nodes for all frames.

The user can customize this program to gain more control. First, he can create his own dynamical images from still images—gray scale, color, increasing or decreasing resolution, erosion, dilation, as well as any combinations of them. He can also create his own Evaluation function by choosing his own integrands, or his own version of persistence. He can use the output (i.e., the boundaries and the Betti numbers) of the algorithm to create his own visualizations of the image (for example, replace the background in a photographic picture), deform it, or further study the image.

The simplification can be localized to an area chosen by the user. For example, the area to be simplified is marked with a mouse. Then the function f(x,y) is chosen small in this area and large outside. As a result, the features outside this area are not affected by the chosen size restrictions.

The following modification can be used to speed up the algorithm if simplification is the only goal. If, for a given frame, the image has been simplified, some pixels have been added. Then add these pixels to all the consecutive frames, before they are processed. This is especially applicable to growing dynamical images, e.g., gray scale image or thickening point clouds. One can also remove the pixels that have been removed from the previous frames.

Visualization.

Suppose the dynamical image comes from a gray scale image. To visualize it, the active 0-cycles are filled with the current gray level while the active 1-cycles are filled with white, as follows. Starting with gray level 0, a recoloring procedure is carried out for each level of gray from 0 (black) to 255 (white). Given a gray level, one changes the colors of some pixels in each row of the image to this new color. One moves along the row until an active edge is crossed. Then, until another active edge is reached, the pixels are redrawn using this gray level. After next active edge, the recoloring stops, until another active edge is reached, etc. Since an inactive feature is bounded by inactive edges, it will be missing from the output as it adopts the color of the surrounding area.

Suppose the dynamical image comes from a video sequence. Then, for each frame, a similar recoloring procedure that switches between black and white is carried out. For a 3D image, the same is done for each slice before they are combined into a 3D picture.

Simplification and visualization of a point cloud is carried out as follows. First it is thickened. It is done until the set is connected, or until the convex hall is reached, or for as many steps as set by the user. This is followed by a topology preserving erosion. The result is a binary image.

Second Embodiment.

The provisional application described the method of the first embodiment applicable to 2-dimensional images with 1 or more parameters. It's single-parameter version was implemented as a C++ program. FIGS. 1-7 have been created by this program. The present description develops the method for images of arbitrary dimension with an arbitrary number of parameters.

Applications of Dynamical Images.

By a dynamical image of dimension (m,n), or an (n,m)-image, in the present embodiment we understand an m-dimensional array of n-dimensional objects. Dynamical images are also called image arrays. These objects are aligned, for example, by being subsets of the Euclidean space. Then the objects are black and their complements are white. Then we have an array of binary n-dimensional images which we will call frames. Each homology class of each frame is traced to all adjacent frames and its lifespan is the collection of all frames of the dynamical image that contain this homology class.

Suppose we are given m one-parameter n-dimensional dynamical images, or (n,1)-images, of the same size. Their combination may be treated as an object with an m-vector assigned to each of its pixels (cells, points). The change from frame to frame is treated as the result of the change of this vector. For each combination of the m parameters, we have a binary image. Therefore, this is an (n,m)-image.

Some examples of (3,1)-images are the following: (1) Black-and-white 3D movies, where the single parameter is time. (2) Gray-scale 3D images, where the gray level is the only parameter. The parameter may also be the pressure, temperature, density, etc. (3) A black-and-white 3D image (and especially a point cloud), where the parameter is the step number in the process of dilation and/or erosion, or any other morphological operation. Combinations of all three are possible such as color movies. The number of parameters may be arbitrary. A color image expressed in terms of red, green and blue (the “RGB” format) or in terms of a luminance component and two chrominance components (“LHS”) is a rectangle with a 3-vector attached to each pixel. Therefore, it is a (2,3)-image. A vector assigned to each pixel could also be the velocity of a flow, or the gravitational force, etc. In imaging, such an image can be created by combined MRI and PET scans in radiology or, more generally, through the fusion of a spectrum of sensors (optical, thermal, etc.) in a multichannel scanner.

The applications and the output for these three examples are identical or similar to the ones of the 2D algorithm. (1) Detection, tracking of objects, denoising, counting (the change of) the number of objects depending on their size or lifespan. (2) Partition of an image, denoising, extraction of features. (3) Combinatorial representation of point clouds, detection of large features. For all three, simplification and computation of topological characteristics, such as Betti numbers, of both the original and the simplified images.

A sample application of Betti numbers is as follows. Employing magnetic resonance data sets is a non-intrusive method that allows the use of three-dimensional computer modeling to create images of the internal organs. As a result, doctors are able to determine the state of these organs, for example the integrity of the scull, or blockage of an artery, or the presence of a tumor. Currently, computers assist the doctors by placing a mark on an area of possible problem such as a breast cancer tumor. If a possible tumor is quantitatively described (in terms of its size, shape, contrast, location, etc) prior to the examination, this task can be carried out by the current method by identifying and displaying features with these characteristics. In addition, for the purposes of screening, a preliminary diagnosis can be done entirely by a computer. One examines 2D or 3D gray-scale density maps of the human brain (scull, bones, etc) as follows. Through thresholding, one obtains a collection of black-and-white images and treats them as a dynamical image. The latter is processed through the present algorithm to discover large-scale features of the image. Only these features are counted when the topological characteristics (Betti numbers) of the image are displayed or otherwise used. Finally, the Betti numbers are compared to the ones of the sample image (the same patient's previous image or an image in a database). For example, the first Betti number, B₁, will be lower than before if arteries have been blocked. In case of a fractured scull, B₁ will be higher than before. In a similar fashion, the invention is applied to other areas requiring image processing and recognition: geographic information systems, map matching, scenery description and analysis, computer reading, computer vision in general.

More generally, a dynamical image is a possibly time-dependent plurality of objects as frames aligned with each other in a common space or ambient objects, and an adjacency relation defined on this plurality.

The Method of Topological Decomposition and Analysis of the Image.

The method consists of four parts: (1) creation of a dynamical image from a collection of still images with parameters, (2) the computation of the homology generators (described in detail in the next section), (3) simplification, and (4) visualization.

As before, each frame is partitioned into a collection of regions: connected sets of black pixels and connected sets of white pixels. Beyond that, higher dimensional cycles that represent the homology classes of the image are used, as shown in “Topology and Geometry” by Bredon, Supra. These cycles are constructed through an incremental process as cells, one by one, are added to and removed from the current frame to transform it into the next or adjacent frame.

The previously described algorithm is extended to process n-dimensional dynamical images consisting of arrays of cell complexes (simplicial, cubical, geometric, or CW-). In general, cell complexes are made of cells that can have an arbitrary number of faces of all dimensions and different shapes. It is typically assumed that a k-cell is homeomorphic to a k-ball. Thus, a k-cell is a k-dimensional polygon, possibly curvilinear, together with its orientation, i.e., the order of vertices. Further, k-cells are attached to each other only along their boundaries, which are made of (k−1)-cells. As a result, the cell decomposition of the frame is a directed graph of cells with arrows pointing from a k-cell to all of its (k−1)-faces. As explained in the first embodiment, a binary image can be represented as a cubical complex. Therefore, a binary image is an example of a cell complex. So is a point cloud.

Each frame of a dynamical image is a cell complex located within the Euclidean space. A cell complex within this space that contains all the frames is fixed and called the support space of the image. In 2D, it is normally a rectangle. For each frame, some of the cells of this complex are called current. One can think of current cells as black and the rest of the support as white. The collection of all current cells is a cell complex; in other words, it is a subcomplex of the support space. It is the image corresponding to the frame. All operations with the cells are carried out in such a way that the image is always a cell complex. Based on the user's simplification settings, some of the current cells are declared inactive. The collection of all active cells is the simplified image. The simplification is carried out in such a way that the simplified image is also a cell complex.

Thus, the cell decomposition of the image in each frame is represented in the above fashion. As the image develops from frame to frame, cells are added (become black) and removed (become white). For each frame, the current k-cells are preferably maintained as an ordered list. Further, to preserve the cell complex structure of the image, a k-cell is typically not added until all of its faces, which are (k−1)-cells, are added. Therefore, adding a cell means first adding all of its vertices, edges, etc (unless they are already present). Also, a k-cell is not removed unless all (k+1)-cells containing it in their boundaries are removed.

For each frame, the Betti numbers are computed. They give the number of connected components, tunnels, voids, etc. Further, the generators of the homology groups are found as cycles of appropriate dimension. Therefore, there are lists containing a vertex (0-cycle) for each component, a curve (1-cycle) for each tunnel, a surface (2-cycle) for each void, etc.

The data structure for a dynamical image with m parameters is preferably an acyclic directed graph with 2 m edges starting from each node. This means the following. For each frame, the generators of homology groups of the frame are represented as nodes of this graph. To transform this frame into one of the adjacent frames, several cells may have to be consecutively added and/or removed (AddCell and RemoveCell described below). Each generator is related to the generators of other frames by means of the edges of the graph. The arrows indicate merging and splitting of the cycles as we add or remove cells. There are no circular sequences of links.

The Parameters of a Dynamical Image.

Generally, a dynamical image has two dimensions, n and m. We will call n the spatial dimension and m the parametric dimension. Here n is the dimension of the support of the image (or image itself) and m is the number of parameters. Each of these parameters may be of one of the following three types: temporal, color-like, or alpha, corresponding to the three areas of applications described above. Let's consider each type separately assuming that the rest of the parameters are fixed.

A dynamical image with a single temporal parameter is an arbitrary sequence of still images with the same support.

A gray scale image is a (2,1)-image. An RGB color picture is a (2,3)-image as its every pixel has three parameters corresponding to the three colors. More generally, we have m “color-like” parameters represented by an m-vector. The peculiarity of this parameter in comparison to the temporal parameter is that as it grows, the objects in the frames also grow. For a gray level picture, this means that as the gray level grows, white is gradually being filled with higher and higher levels of gray. For a combination of color-like parameters, this means that as these parameters grow, white is gradually being filled with higher and higher levels of combinations of these colors. The cell complex also grows, i.e., cells are added and never removed.

The third type is the parameter of the dilation procedure (or erosion, or another morphological operation). We will call such a parameter an alpha parameter. As it grows, the cell complex also grows. The opposite happens for the erosion procedure.

A dilation of a cell complex may be carried out by several runs of adding cells in the support space adjacent to the current cell complex A topology preserving erosion may be carried out by several runs of removing cells adjacent to the complement of the cell complex in the support space unless such a removal changes the homology of the complex and unless the cell to be removed contains one of the cells of the original cell complex. Alternatively, cells may be added or removed in a single run based on their distance from the original complex.

The Approach to Image Simplification.

One approach to simplification is as before. The user is given an option to remove from the image the features the characteristics of which lie within the limits chosen by him. This is carried out by the Evaluation command. Meanwhile, if all limits are set to zero, visualization of the output produces the original image.

The size-based simplification means removal of features of “small” size. By “size” of a k-cycle, we understand the k-volume of the cycle and, more generally, an integral of a given function along the cycle. These characteristics are preferably computed at every step of the algorithm and kept in the nodes of the graph. From the current frame, a feature is preferably removed if its size is less than a given level. Other characteristics of the objects can be computed as integrals. Those include, but are not limited to, moments (and, therefore, centroids), curvatures, etc.

The notion of lifespan, and the lifespan based persistence, has a new meaning in this context. In case of multiple parameters, a cycle does not have single birth frame, or death frame. The “lifespan” of a homology class of an (n,m)-image is the collection of all frames where the class is present. This collection is typically found by following the links of the graph. Now, since each frame corresponds to a combination of parameters and there are m of them, the frame corresponds to a point on the integer grid in the m-dimensional Euclidean space. Therefore, the “lifespan” of a homology class is a subset of the m-dimensional Euclidean space. The persistence of the homology class is the “size” of this set. The size can be defined in a number of ways but the most obvious is the number of points in this set. A more comprehensive measure is the sum of integrals over the homology class in each frame over its entire lifespan.

For a frame-by-frame simplification, we preferably compute the lifespan of a homology class with respect to a given frame. Then, the lifespan for a given combination of values of the parameters (the current frame) is the set of all combinations of values of these parameters each less than or equal to the current one (“previous” frames), in which this class is present. Given a frame F and a homology class H in it, we say that H is present in another frame F′ if there is a homology class H′ in F′ and a sequence of edges of the graph connecting the nodes corresponding H and H′. The size of the lifespan set of a homology class determines whether it has been persistent enough to justify plotting it in the current frame.

For an (n,m)-image, decomposition and simplification is carried out for the all color-like parameters simultaneously as they are combined into an m-dimensional space commonly called the color space. For a color image, it means the following. Since all combinations of red, blue, and green are possible, one should consider each pixel of the image as a point in the 3-dimensional space, one dimension for each color. Then the change of color of the pixel is represented as a movement of this point in this space. The result of the simplification procedure is three gray scale images, which are combined into a simplified color image. If the dynamical image was constructed from a collection of multichannel images, the output is again a collection of simplified, multichannel images. These images may now be combined (“fused”) into one by means of existing techniques.

It is possible to carry out the whole decomposition and simplification processes separately for each of the three colors as gray scale images and then visualize the combination of the results. This is appropriate when, for example, it is known a priori that all the noise consists of small dots, or rather all small dots (of any color) are noise. Then setting the minimal area of components for each of the three images as, say, 10 will remove these dots. Suppose now that it is known a priori that all the noise consists of small red dots. One may choose then to set the minimal area of components for gray scale image corresponding to red as 10. This will remove all red dots from the simplified color image. However, it will also turn purple dots blue, even if blue is not even present in the original image. Such an outcome is inevitable under this approach. The reason is that treating each color separately means that while the level of, say, red varies, the levels of blue and green remain fixed at zero. Therefore, most combinations of colors are ignored.

Thus, simplification of a color image, or another multichannel image, can be done separately with respect to each element of the spectrum, red, green, and blue. However, putting the three simplified gray scale images together to create a simplified color image may produce colors that were not present in the original image. This happens because not all possible combinations of colors are considered during simplification. This is the reason why these parameters should be treated as a single multidimensional parameter.

To solve the denoising problem above by means of the present method, the settings of the Evaluation command may be the following: For each frame corresponding to red above, say, 50 and green and blue below 20, the minimal area of components is set as 10. This will remove all red dots with blue, green, purple, etc dots unaffected.

In case of color-like parameters, all frames are preferably combined into a new, simplified image. However, if a temporal parameter is present, only the frames corresponding to a given value of that parameter should be combined into a new, simplified frame. This way a new, simplified video sequence is visualized.

Next we discuss the “alpha” parameter. The range of this parameter is set by the user. The nature of a parameter does not affect the way the image is decomposed and analyzed, only the way the image is simplified. As the alpha parameter grows, the image grows, just like in the case of a color-like parameter. However, simplification is done differently.

Assume again that there is no temporal parameter or it is fixed. Now all the frames, including ones corresponding to the alpha parameter, have to be combined into the simplified frame. Suppose all color-like parameters are fixed. The whole set of values of the alpha parameter is processed by thickening the current frame by the number of steps set by the user, or, alternatively, all at once by recoloring all cells within a certain distance from the image. In particular, this may result in several smaller objects merging into a bigger one and some holes disappearing. Next, the result is thinned with topology preserved. The result is that, for this combination of color-like parameters, the complex has changed.

This option is an alternative to the standard alpha shapes technique of surface reconstruction from a point cloud data. In 3D, the above visualization procedure will result in a combination of surfaces one voxel thick.

Often in medical imaging, a single image may be of low quality. Then, a sequence of images may be taken and then combined into an enhanced single image. It makes sense if the difference between the images in the sequence is mostly due to noise and minor variations of the position of the camera. The present method is applicable. The sequence is a dynamical image with multiple color-like parameters and a temporal parameter. Then, the whole dynamical image is simplified by treating the temporal parameter as another color-like parameter. Finally, the simplification of one of the frames in the sequence serves as the output.

The topologically constrained simplification, as well as surface reconstruction and feature extraction, described in the first embodiment applies without change.

Data Structure of the Homology of Cell Complex Representations of Dynamical Images.

Partition is now just a part of a more general topological decomposition of the image. The algorithm preferably computes the homology groups of every frame. As before, the homology classes are preferably represented by nodes of a directed graph and the classes in consecutive, or adjacent, frames are connected to each other by edges of the graph. There is also a pointer from each cell to the homology class that was created when the cell was added.

The following embodiment of the method is for the homology groups over a field. Suppose we are given a frame of the image. A k-homology class in this frame is represented by a chain of k-cells that can be recorded as an M-vector, where M is the total number of k-cells in the frame. As an illustration, a component of this vector is 1 if the corresponding cell is present, −1 if it present with the opposite orientation, 0 if it is absent. The k-boundary operator D is maintained as an M×N matrix where N, the number of rows, is the total number of (k−1)-cells in the frame. Then the boundary of a chain C is the matrix product D*C. By means of D, it is easy to verify whether any two k-chains, A and B, are “homologous”: the difference between them is the boundary of a (k+1)-chain T: A−B=D*C. The existence of T is verified by the standard linear algebra techniques. In this case, A and B belong to the same k-homology class H=[A]=[B]. Examples of A and B are: two vertices in the same component of any cell complex (k=0); two meridians of a torus, but not a meridian and the equator (k=1); the inner surface and the outer surface of a thick sphere (k=2). These chains are “cycles”: they have zero boundary, D*A=0. They are also “nonzero”: they are not boundaries of (k+1)-chains. Each homology k-class can be represented by one of its k-cycles. At each step of the algorithm maintains a list of cycles the homology classes of which generate the homology group. These cycles are called homology generators or simply generators.

The collection of generators for all frames of the image preferably is also maintained as the set of nodes of a directed graph. The appearing, disappearing, splitting, and merging of the homology classes is preferably recorded as before by adding edges and nodes to this graph. Based on this information, the lifespans of homology classes are computed and used for simplification. For size-based simplification and other applications, a line, surface, . . . , k-volume integral over any 1-, 2-, . . . , k-cycle is computed in the usual manner, i.e., by visiting every edge, face, . . . , k-cell of the cycle respectively. This data is preferably recorded in the corresponding node and used by the Evaluation command after each frame is decomposed.

It may be necessary to maintain the complete list of elements of each homology class. Then, the integral of a homology class is preferably the minimal integral of all cycles in the class.

For n=3, the integral corresponding to a 1-cycle C is a line integral of a vector field V along C. The reason why it makes sense to measure the size of the loop C by this integral is explained by the following example. If V is the magnetic field produced by some electric current, the integral is proportional to the amount of the current flowing through the loop (Ampere's Law).

For k=0, the generator of a 0-homology class (connected component) is a single vertex of the component. Thus, 0-generators provide the partition of the complex. To simplify computations, the list of vertices in each component may be maintained. Then the size of the class is the volume integral over the component. Alternatively and similarly to the first embodiment, components may be recorded by means of their outer boundaries, which are represented by some (n−1)-cycles. Then the size of a 0-cycle is an (n−1)-integral over this cycle, just like in the first embodiment. In this case, instead of the volume of the component itself, the volume of the 0-cycle may be the volume of what is enclosed by its outer boundary (and that would include the holes).

The generalization of this method to the computation of the relative homology and cohomology is obvious to a person skilled in the art.

Just as in the first embodiment, three Boolean arrays of the same size are preferably used: previous frame (P), current frame (C), and next frame (N). P and N are frames of the dynamical image; C is the current state of the image as it develops cell by cell from P to N. The cycles found in C are called “current”. The cycles in N that remain after simplification are called “active”.

Each node of the graph preferably contains only two pairs of links (pointers) to previous and next nodes. If the cycle is merged with another, there is one link, if it splits, two. There is also preferably a pointer to the “info node” containing: the dimension of the node, the frames of birth and time of death, a pointer to the cell that created the cycle, the other integrals, etc. This node can be deleted when the cycle ceases to be current, i.e., after a merge or a split. For the sake of fast visualization of the active cycles, the pointer to the next active node is preferably also maintained.

The AddCell and RemoveCell Commands.

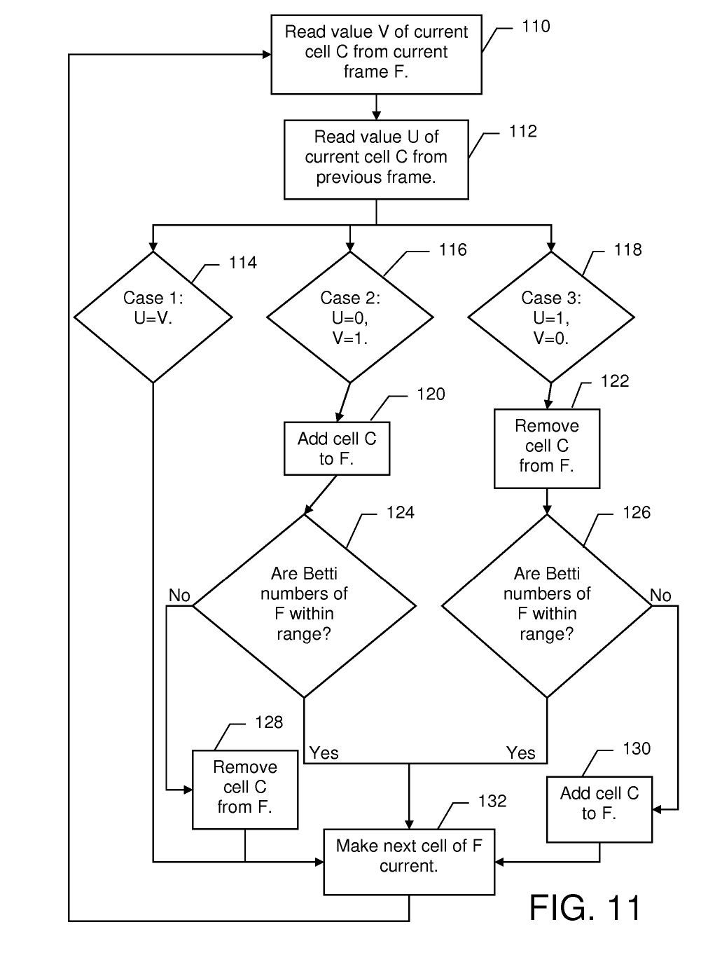

C transforms over time from P to N as follows. At every step of the run through the image, the cell in P is compared to the corresponding one in N. If the colors are the same, skip to the next step. If the color changes from white to black, execute AddCell. If it changes from black to white, execute RemoveCell. Every time the geometry of the image changes, the list of cycles and the graph, the numerical characteristics of the cycles, and the Betti numbers are typically updated. The processing is described in FIG. 11.

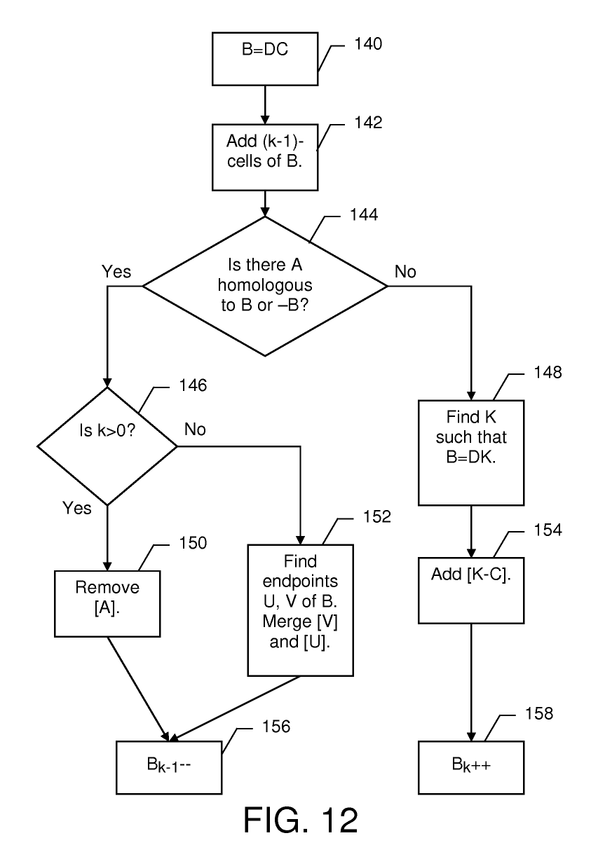

First, we consider the AddCell command (FIG. 12). As a new k-cell C is added, a (k−1)-homology class may disappear or some k-homology classes may appear or split. First, the boundary of C is computed as a (k−1)-cycle B=D*C, step 140.

If there is a (k−1)-generator A homologous to B or −B, step 144, its homology class [A] is removed, step 150, provided k>1, step 146. In case of k=1, the components connected by the edge C are merged as 0-homology classes into a new one, step 152. It is done by preserving one vertex of the two representing the components (alternatively, the lists of all the vertices in the two components are merged into one). This event is recorded in the graph. The (k−1)-Betti number (Bₖ₋₁) goes down by 1, step 156.

If there is no such class A, step 144, B is the boundary of some k-chain K, B=D*K. Then take one such chain K and form a new k-homology class [K−C]. Alternatively, suppose there is a generator of the form K−K′, where K and K′are k-chains with B=D*K=D*K′, step 148. Then split the class [K−K′]0 into two, [K−C]and [C−K], step 154. The choice of this class depends on the circumstances. However, in case k=n−1, we may choose to split a specific class [K−K′], the one that encloses C. This event is recorded in the graph. Alternatively, the graph reflects that a collection of, say, m, such classes split into a collection of m+1 classes. The k-Betti number (Bₖ) goes up by 1, step 158.

Finally, the k-boundary operator D is updated by adding a new column equal to the vector determined by B.

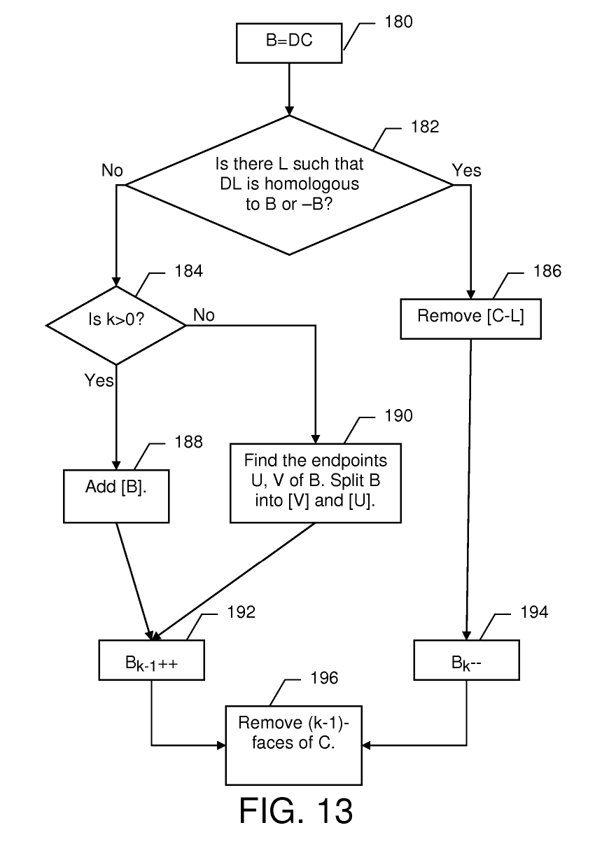

Next we consider the RemoveCell command (FIG. 13). As an existing k-cell C is removed, some k-classes may disappear or merge, or a new (k−1)-class may appear. First, the boundary of C is computed as a (k−1)-cycle B=D*C, step 180.

If there is a k-chain L with boundary D*L homologous to B or −B, step 182, then some k-homology class is represented as H=[C−L]. Then one of such classes is removed, step 186. Alternatively, suppose H=[C−L] and H=[C−L] are two such classes. Then they merge into one class M[L−L′]. The choice of this pair of classes depends on the circumstances, but when k=n−1, we choose L, L′such that L−L′is the cycle that encloses C. This event is recorded in the graph. Alternatively, the graph reflects that a collection of, say, m such classes merge into a collection of m−1 classes. The k-Betti number (Bₖ) goes down by 1, step 194.

If there is no such k-class L, step 182, then the (k−1)-homology class H=[B] is added, step 188, provided k>1, step 184. In case of k=1, step 188, the 0-cycle (component) is split into two by recording the two end points of the edge C as vertices representing the new 0-homology classes (alternatively, all the vertices in the component are split into two new components), step 190. This event is recorded in the graph. The (k−1)-Betti number (Bₖ₋₁) goes up by 1, step 192.

Finally, the k-boundary operator D is updated by removing the column equal to the vector determined by B, step 196.

Suppose a k-cell C is removed and two k-classes H and K merge to create a new class M. Then, the integral of M is found based on the knowledge of those of H, K, and the computation of the integral over C. No further integration is necessary because integral is additive. Suppose a k-cell C is added and M splits into H and K. Then the integral over H is calculated by visiting its every cell, and the integral of K is found based on the knowledge of those of H, M, and the computation of the integral over C.

Images With Multiple Parameters as Dynamical Images.

An (n,m)-image may come from an n-dimensional cell complex with m-vectors assigned to each cell, such as color photos (n=2, m=3), a flow (n=2 or n=3, m=3), etc. And vice versa, such a cell complex can be easily constructed from an (n,m)-image if there is no temporal parameter. In general, the conversion procedures are as follows.

Suppose we are given a t-dimensional array of n-dimensional cell complexes with s-vectors assigned to each cell. Then a dynamical image is constructed as follows. First, the t parameters of the array will serve as temporal parameters of the dynamical image. Suppose these parameters are fixed. This gives us a cell complex with s-vectors assigned to each cell. From this complex, we construct a dynamical image with s color-like parameters. These parameters serve as thresholds for the components of the vectors. More precisely, suppose all color-like parameters are fixed. Then a cell complex is constructed as follows. If k^{th} component of the vector at a given cell is larger than or equal to the value of the k^{th} parameter, this cell and all its faces are included in the new cell complex. This cell complex is the frame corresponding to the given combination of parameters. Finally, all frames together form an (n,t+s)-image.

Conversely, suppose we are given an (n,t+s)-image with t temporal parameters and s color-like parameters. Suppose all temporal parameters are fixed. Next, we fix all color-like parameters but one, p^{th}. Then what remains from the dynamical image is a growing sequence of complexes. Let K be the union of these complexes. Now, for each cell of K, we construct the p^{th} coordinate of the vector. If a given cell belongs to the k^{th} element of the sequence but not to (k+1)^{st}, then let the p^{th} coordinate be equal to k. If we repeat this procedure for all s color-like parameters, we constructed a t-dimensional array of n-dimensional cell complexes with s-vectors assigned to each cell.

An n-dimensional cell complex with m-vectors assigned to its cells is related to the computational image model in U.S. Patent Application No. 20050232511, Supra. However, mathematically, it is simply a vector field.

The information encoded in a dynamical image can be combined in one cell complex K. Suppose first that we are given an (n,1)-image as a sequence of complexes contained in the n-dimensional Euclidean space E. Then K is a subset of the (n+1)-dimensional Euclidean space with cross-sections identical to the elements of the sequence. Suppose now that we are given an (n,2)-image as a 2-dimensional array of complexes contained in the n-dimensional Euclidean space. Then K is constructed in two steps. First, for each value of the first parameter, we have an (n,1)-image and we construct its representation as an (n+1)-complex by the above procedure. Second, this sequence of complexes is combined into a new (n+2)-complex, again by the procedure above. Inductively, an (n,m)-image is represented as an (n+m)-complex in m steps of such a procedure.

Processing of Dynamical Images With Multiple Parameters.

The first embodiment is for a (2,1)-image, (n,1)-images are discussed above, an example of a (2,2)-image is described in the next paragraph.

To process a gray-scale video, the algorithm is used as follows. Each of its frames is a dynamical 2D image (the parameter is the gray level) treated as above (or as in the first embodiment). Now in addition, every gray level is also a dynamical 2D image (the parameter is the frame number). Thus, the spatial dimension is 2 and the parametric dimension is 2. The algorithm is applied independently with respect to these two parameters. Previously, the node of a cycle contained links to the previous and next nodes with respect to the gray level. Now there are also links to the previous and next nodes with respect to the frames of the image. They are treated as the second parameter of the two-parameter dynamical image.

Each frame is processed by the above algorithm as a dynamical 2D image. Starting with the second frame of the video, the links to the cycles of the previous frame are established at every step of the algorithm. Specifically, these cycles are in the same gray level. Since each gray level is a binary image, the processing does not differ from that of a binary video. Suppose C is a 2-cell (pixel) that is added to the second frame during a step of the algorithm. Now, we check if C is present in the first frame at the same gray level. If it is, do nothing. If not, execute AddCell with C applied to the given gray level of the first frame. Similarly, suppose C is removed from the second frame. Now, we check if C is present in the first frame at the same gray level. If it is not, do nothing. If it is, execute RemoveCell with C applied to the given gray level of the first frame. This algorithm directly applies to 3D gray scale images, if you treat slices of the image as frames of the video.

The above example shows how one executes a partition algorithm for dynamical images with the parametric dimension above 1: extra parameters are added to the original algorithm. For example, a color picture is an (2,3)-image, where the three parameters at each pixel are red, blue, and green. The algorithm above shows how to process any (2,2)-image. In particular, it applies to an image with red and blue but no green. To add green, add another parameter.

An (n,3)-image is treated by adding an extra parameter to the algorithm for (n,2)-images. For each value of the third parameter (green), the first two parameters (red and blue) are treated via the algorithm above. Thus, for each value of the third parameter (green), we have a graph that records splits and merges of the image as the first two parameters (red and blue) vary. In addition, these graphs are connected to each other by means of extra links as above. The result is a single graph with three pairs of links for each node.

Thus, this (inductive) chain of higher and higher parametric dimensions and algorithms continues. By adding an extra parameter to an image with the parametric dimension m, we obtain an image with the parametric dimension m+1. And so on. The result is an algorithm for an (n,m)-image.

Simplification and Visualization.

The output of simplification of an (n,m)-image is a new, simplified (n,m)-image. However, if the (n,m)-image came from a collection of multichannel still images, the output of visualization may be a new collection of simplified multichannel images. For example, if the input is a combination of an MRI and a CT images, the output is a simplified MRI image and a simplified CT image. Thus, an MRI helps improve a CT image, and vice versa. Similarly, if the dynamical image came from a video sequence, the output is a new, simplified sequence. More generally, we use the conversion procedures described above. First, we convert an array of complexes with assigned vectors into a dynamical image. Then, we simplify this image. Finally, we convert the simplified dynamical image back to the original format, which is the same array of complexes but with new assigned vectors.

The data structures for both original and simplified images may be maintained, or only the one for the latter. The output of the algorithm for each frame of the original image is a collection of generators recorded in a directed graph. Next, the Evaluation command either accepts or rejects each of these cycles based on whether their characteristics are within the limits set by the user. The remaining cycles, as well as the homology classes they represent and the cells they contain, are called active.

Suppose we have only color-like parameters. Then the visualization of the simplified image is typically carried out as follows. The whole picture starts white. Then we run through all frames as the parameters run through all their values. Each new frame adds something to the picture. Each frame corresponds to a combination of values of parameters, which will be called the current color. This color is used for recoloring active cycles in the frame.

The removal of 0-cycles and (n−1)-cycles from the image is similar to that for the case n=2, the first embodiment, because these are simply the components of the image and the voids in the components. Even though the components are recorded by their vertices, it is easy to find their outer boundaries as (n−1)-cycles. One simply records all (n−1)-cells that border both an n-cell that is in the image and one that is not.

In the case of a rectangular grid recoloring is done as follows. Starting with white, one moves along each row of n-pixels without changing their colors. It switches to the current color as soon as a vertex homologous to an active vertex (0-cycle) is reached. The ability to identify such a vertex can be achieved by maintaining a list of vertices in each component, or by maintaining 0-cycles as (n−1)-cycles that bound them from the outside, or by finding a vertex homologous to an active cycle. Then the combination of the values of the parameters recorded at each pixel is compared to the current combination. For each parameter, the larger of the two is chosen and recorded at the pixel. Thus, the pixel may become darker. After the first active (n−1)-face the color switches back to white and recoloring stops. After the next active (n−1)-face, the color switches back to the current color. All pixels in the row are recolored in the above fashion until an inactive vertex is reached. And so on. Since an inactive component consists of inactive vertices and an inactive void is bounded by inactive faces, they will be missing from the output as they adopt the color of the surrounding area. More precisely, the pixels of inactive 0-cycles are not colored, while inactive (n−1)-cycles are filled the current color.

An alternative method is to have a cycle over cells instead a cycle over frames. Then, for each cell, a parameter is maximized over all of its values for which the cell is active. In case of an arbitrary cell complex, this approach allows cells to be checked one by one in no particular order.

When a 0-cycle is removed, all k-generators with k>0 (tunnels, voids, etc) “residing” in this component are removed as well. They are removed from the picture because the component is not plotted. In addition, these generators are removed from the graph by removing all nodes connected to that of the 0-cycle and the result is recorded as the graph of the simplified image.

If the 0-cycle containing an inactive k-cycle is not being removed, the k-cycle has to be deleted in a different manner. This happens, for example, if the hole in the donut (k=1, n=3) has to be closed or if, more practically, little handles that appear during reconstruction of the surface of the brain have to be removed. Such a feature may be removed through a version of the method described previously: dilation followed by topology preserving erosion, as follows. The k-cycle C, as a collection of vertices (or pixels, or k-cells) separate from the image, is thickened until C disappears as a k-cycle. In particular, one can simply take the convex hall of C or a ball around C. Next, a topology preserving erosion that keeps all original cells is carried out. Then C as a k-cycle does not reappear, therefore C is a boundary of a (k+1)-chain K. One can think of K as a “membrane” on C. In the unlikely event that C is knotted, K will have selfintersections. To visualize the simplified image, add K as a collection of vertices (or pixels, or k-cells) to the original frame. To maintain the data properly, this is accompanied by executing AddCell for each cell of K and record the result in the graph of the simplified image. If this creates a new (k+1)-cycle L, execute Evaluation and remove L if necessary.

This procedure may have to be repeated for all cycles homologous to C. For example, it may be necessary to completely patch up the hole in a donut instead of just closing it with a membrane. Alternatively, the whole set is thickened and then it is thinned so that not only the topology is preserved but also no cycles homologous to C in the original image are allowed to reappear.

In addition, simplification of the image through simplification of its complement may be useful. For example, if a donut has a big hole it will not be removed (by filling) even though the donut has a thin cross-section at some point. The latter fact is discovered if the size of the 1-cycle of the complement of the donut is evaluated. Then, this cycle is removed by cutting the donut. More generally, the complements of the images in each frame form a dynamical image, which can be analyzed and simplified by the present method. The complements of the frames of the simplified complement form a simplification of the original image.

Suppose that as a result of simplification with respect to color-like parameters some cells have been added to a frame. These cells can also be added to all frames with larger or equal values of the parameters. For example, add K to avoid having to remove C from the next frame. The result is a faster execution.

Variations of the Method.

The algorithm can be applied to pictures (support spaces) with topology different from that of a rectangle. For example, it applies with virtually no change to pictures with missing parts or panoramic shots. The image can have an unstructured grid, for example, a grid that have higher resolution (and smaller pixels) closer to the middle of the image. More generally, the method applies to parameterized cell complexes. The algorithm can be executed with a different data structure, for example, a database instead of a graph.

As the image develops, generators “merge” and “split”. The operations on generators can be carried out in such a way that they satisfy the following conditions.

(1) The generators are minimal in the sense that none of them contains (as a chain) another non-homologous non-zero chain. For example, if the image is the union of two overlapping circles, neither of the circles is a generator. Instead, the generators are the three 1-cycles corresponding to the three holes.

(2) The cells of the generators belong to the boundary of the image. Further, the cells of the (n−1)-generators belong to the inner boundary of the image. For example, the inner surface, not the outer surface, of a thick ball is the 2-cycle that represents the 2-homology class of the void.

(3) For k=n−1, the generators are also minimal in the sense that if an (n−1)-generator K encloses a cell of another (n−1)-generator L, then K encloses the rest of the cells of L. Thus, these generators do not cross. For example, if the image is the union of two overlapping spheres in 3-space, neither of the spheres is a generator. Instead, the generators are the three 2-cycles corresponding to the three voids.

In another embodiment, the cells are added and removed not one by one but in groups. For example, all new cells in the current frame are added as a single set and all outdated cells are removed as a single set. The homologies of these sets are computed by the above algorithm or any other method. Then, based on this information and the knowledge of the homology of the image in the previous frame, the homology of the image in the new frame is computed by means of the Mayer-Vietoris theorem. Another application of this theorem is in computing the homology of the whole image after the homologies of its pieces have been computed, such as in a parallel processing procedure.

In addition to the evaluation of the homology of the frames of the dynamical image with a given support, we may compute the homology of the complements of the complex in each the frame. These complements form a new dynamical image. The output of the algorithm is two graphs connected with each other via the Alexander Duality. In case of a gray scale image, the algorithm produces analysis and simplification of the negative of the picture.

The space of parameters does not have to be Euclidean. For example, if the magnitude of the velocity vector is fixed, the parameter space is a sphere. However, the algorithm applies without change.

The level of gray at each pixel may run within a range of values, for example, an interval. In this case, both the collection of the highest values and that of the lowest values of these intervals create a dynamical image. Either one is represented by a graph. Then, these two dynamical images are combined into a new one with an extra parameter and their graphs are connected to each other. The persistence with respect to this parameter will reveal what cycles exist for all values of the gray within the given range.

If there are memory restrictions, the simplification of the graph representing the image is possible. The graph can be “pruned” by removing nodes corresponding to “small” cycles. Moreover, any inactive node can be removed without loss of information if the corresponding edges are reassigned by traversing the cycle.

Instead of a geometric object with vectors assigned to its parts, more generally, we may consider other algebraic entities. The algorithm is applicable as long as such an entity can be treated as a vector. For example, an n by m matrix can be treated as an nm-vector.

Every parameter can be treated as another spatial parameter. In other words, an (n,m)-image may be an (n+1,m−1)-image. For example, in a time sequence of 3D images the temporal parameter can be treated as a spatial one. The result is a 4D still image, such as simplicial complexes in U.S. Pat. No. 6,674,432 titled “Method And System For Modeling Geological Structures Using An Unstructured Four-Dimensional Mesh” to Kennon, et al.

Conclusion.

Thus, the method provides a topologically faithful representation of the image without approximation or loss of information. It is also simpler, faster, more robust, more versatile, easier to customize, and has broader applications than known methods. Unlike most of the prior art, it is mathematically proven.

Other Applications.

Removing, Adding, and Extracting Topological Features.

A method of removing cycles and homology classes from a cell complex is the simplification procedure described above. Next we consider way to add topological features to the image.

During simplification, just as before, the current topology settings can be protected in the sense that adding or removing pixels is not allowed to change the topology of the image. This is done by keeping the Betti numbers constant. This and other examples below resemble cellular automata. However the difference is that in the present method the global information about the image, i.e., Betti numbers, is also taken into account.

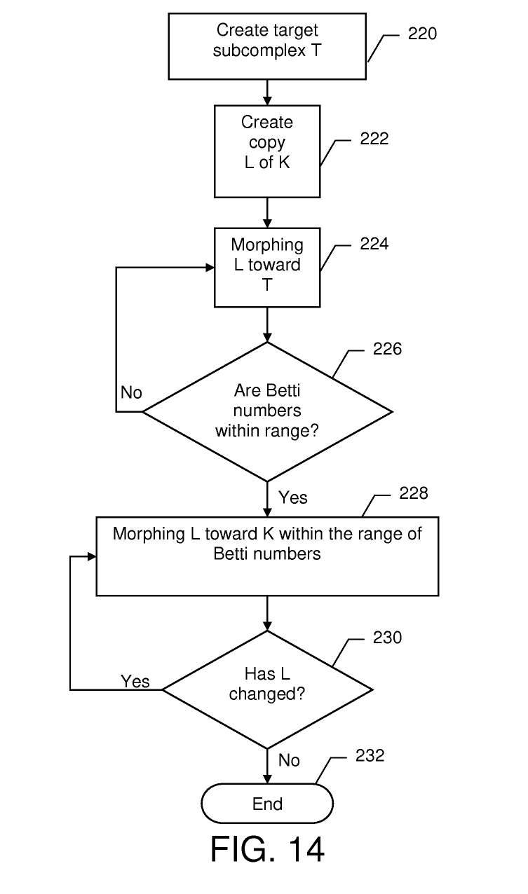

Suppose AddCell or RemoveCell results in the change of the Betti number that we want to preserve. Then the change of topology is immediately undone by executing RemoveCell or AddCell respectively, with the same cell (FIG. 14). For example, to preserve the number of components, it suffices to preserve the 0th Betti numbers. On the other hand, by preserving only the 1st Betti number (B₁), the user allows merging and splitting of components but prohibits the emergence or disappearance of handles.

This option makes possible a method of surface reconstruction. Suppose we have a point cloud in a cell complex. Represent each point by a cell it contains. This results in a subcomplex. Next, we construct the following dynamical image. In the first stage, it develops through dilation, i.e., adding to the subcomplex each cell adjacent to it. The process stops when we have a connected subcomplex (B₀=1). In the next stage, the dynamical image develops through topology preserving erosion, i.e., removing from the subcomplex each cell adjacent to its complement, with additional restriction that the original cells are not removed. The process stops when there is no more change. In the last frame, we have a collection of surfaces in 3D one cell thick. For a gray scale image, this procedure is typically carried out for each gray level.

As another example, this option may help to ensure that the object has the correct topology. For example, the standard algorithms of representation of the surface of the brain suffer from the presence of small handles. Special techniques are devised to remove these artifacts and ensure that the genus of this surface is zero. However, these handles disappear under thickening of the brain. The dilation is carried out until B₁=0. It is followed by topology preserving erosion. The result is the image of the brain the surface of which is topologically equivalent (up to the thickness of the “surface”) to the sphere. Another way of removing handles is by directly removing the corresponding homology classes as described in the second embodiment. Yet another approach is to cut the handles by executing erosion followed by topology preserving dilation, described below.

In these examples, either the inner or outer boundary of the resulting object is a true curve (made of edges of pixels) in 2D or surface (made of faces of voxels) in 3D. Another way to obtain a true curve or surface is to have the above algorithm reject not only pixels but also faces and edges.

The topology preservation option allows a simple feature extraction method. Suppose we are given a binary image. It may contain a single object such a human body. Now we want to extract the features of the object such as the head, hands, etc. Of course, they do not exist as separate objects. Then we use the following dynamical image. In the first stage, it develops through erosion. The process stops when we have several components (B₀>1). In the next stage, the dynamical image develops through a topology preserving dilation with additional restriction that the pixels originally outside the image remain white. The process stops when there is no more change. In the last frame, we have the original object cut into pieces. The cuts appear in the narrowest areas of the object. These cuts are one pixel (or cell) wide. Now, these pieces can be recorded as separate objects or images. To extract more features, apply the procedure to these objects. In an object tracking system, following extracted features will increase quality of matching and tracking.

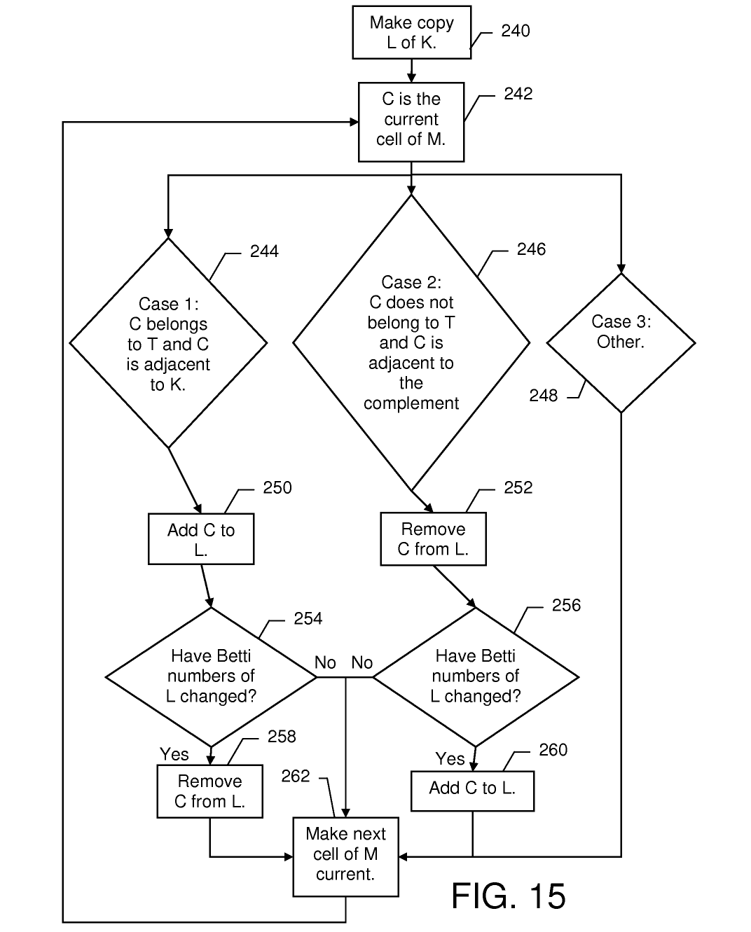

More generally, we use morphing of a given subcomplex of a cell complex into another, target, subcomplex (FIG. 15). Each step of the method is a sequence of the two operations: (a) adding to the current subcomplex a cell adjacent to the current subcomplex, provided the cell belongs to the target subcomplex, and (b) removing from the current subcomplex a cell adjacent to the complement of the current subcomplex, provided the cell does not belong to the target subcomplex. As before, we follow the rule: if a cell is added then so are all of its faces and if a cell is removed then so are all of its faces unless they are also faces of other cells. In the most typical case, a dynamical image is a collection of n-pixels being added and removed.

The method is used to deform a given subcomplex into a new subcomplex with Betti numbers within a specified range. First, a subcomplex with Betti numbers within the specified range is created. Second, the original subcomplex is morphed into the new subcomplex by the above method until its Betti numbers fall within the specified range.

Further, this method provides a method of topologically constrained morphing of a given subcomplex into another subcomplex. One uses the steps of the morphing, unless such a step would take Betti numbers of the current subcomplex out of a specified range. Another application is a method of transforming a given subcomplex of a cell complex into a new subcomplex with Betti numbers within a specified range. First, create a second subcomplex with Betti numbers within the specified range, and, second, execute topologically constrained morphing of the second subcomplex into the original subcomplex.

Special instances are the following. Dilation of a subcomplex followed by a topology preserving erosion to create a new subcomplex with Betti numbers within a specified range is understood as the above method with the second subcomplex created by deforming the original subcomplex into the ambient cell complex. Erosion of a subcomplex followed by a topology preserving dilation to create a new subcomplex with Betti numbers within a specified range is understood as the above method with the second subcomplex created by deforming the original subcomplex into the empty complex.

Another application is the generalization of the above method of removal of a k-homology class from a cell complex. First, represent the generator of the homology class as a subcomplex of a new cell complex with the k-Betti number (Bₖ) equal to 0. Second, transform the resulting subcomplex into a new subcomplex with the k-Betti number (Bₖ) equal to 0 by means of the above method. Third, add the resulting cell complex to the original cell complex. Another way to remove a homology class from a subcomplex is to apply the above method with the extra condition: a cell is removed unless the removal creates a cycle that belongs to the homology class.

Object Tracking.

For video processing, the algorithm's output is used to detect and track objects, as well as denoise. In particular, the plotted objects are tagged and their numerical characteristics (areas, locations, velocities, lifespans, etc) are displayed. A slow moving object, i.e., such that its representations in two consecutive frames overlap, is traced simply by means of the graph itself. It is possible because the two representations are recognized as the same object (in the graph, they are connected by an edge). Its location is computed as its center of mass, via computation of its moments as integrals along its boundary. Computed for two consecutive frames, the locations provide the displacement and, therefore, the velocity of the object. If, alternatively, the objects are assumed fixed, this velocity if that of the camera. Meanwhile, the sizes (perimeters, shapes, etc) and lifespans of the objects are computed as before, therefore, simplification based on this information is carried out as well. As the objects are extracted from the image, they may be compared and matched with ones in a database.

Similarly to the velocity, the rate of change of the size of the object (for example, if the object is getting closer) is also evaluated. As a result, both the location and the size of the object in the next frame can be predicted by extrapolation. Moreover, the shape of the object can also be predicted by computing the rates of change of its moments, width and height, etc.

The predicted location and size and shape of the object have the following application. When the representations of the object in two consecutive frames do not overlap, they are not recognized by the algorithm as the same object. A way to deal with this problem would be to enlarge all objects so that each would overlap with its copy in the next frame. However, a more reliable way is to match the two objects, as follows. The algorithm discovers that a “large”, according to the user's settings, object has disappeared in the first frame and another appeared in the second. If the location and size (shape, etc) of the second object matches the predicted location and size of the first object in the second frame, the two objects are taken as the same object. An edge connecting their nodes in the graph is added. The objects can also be matched by an appropriate registration method. If there are several candidates, choose the best match. An identical matching procedure applies when two different objects cross their paths for a moment and afterwards have to be identified. Other matching methods are described below.

The algorithm can be performed in real time and continuously convert one signal into another. The first signal is the current image as it reaches the camera and the second may be the command to turn the camera to follow the object traced by the algorithm.

Using Simplification for Image Compression.

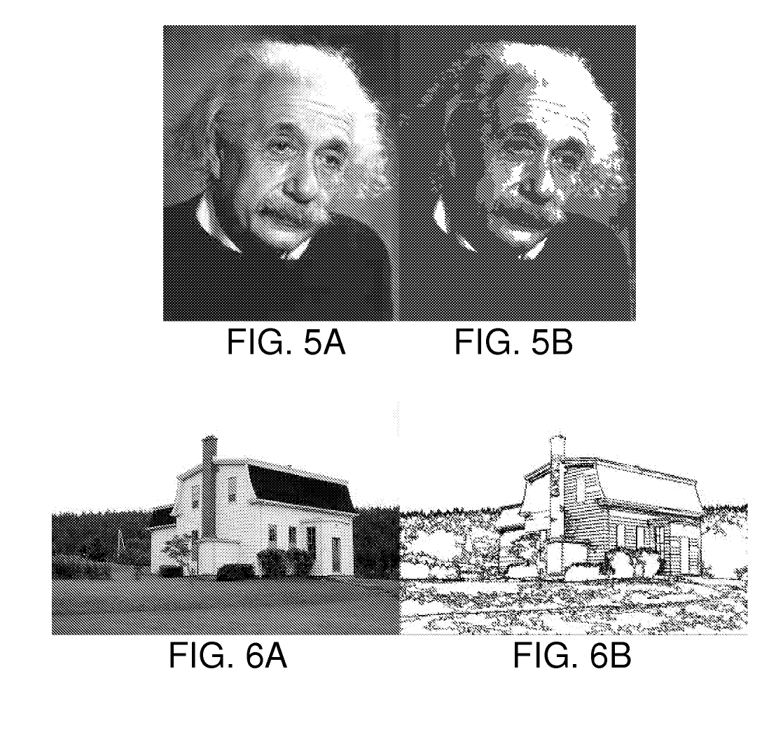

Contrast based simplification can be used for image compression. Suppose we want to reduce the number of levels of gray in the image N times, from 256 to 256/N, where N is a power of 2. Then run the algorithm with the threshold T=256/N. If now the recoloring function is chosen to be [L/T], the output is a contrast-based compression of the image. The example in FIG. 5 has 4 levels of gray. The example in FIG. 4D has 2 levels of gray. This approach to compression is preferable to the usual, threshold-based method, as it preserves high contrast features regardless of their gray levels. In an alternative application of the method in compression, all regions with a given gray level are appropriately dithered.

While contrast based simplification is used for image compression in terms of bit-per-pixel, the size based simplification can be used for compression in terms of pixel-per-inch. Suppose we want to reduce the size, in pixels, of a gray scale image by ⅔ for both dimensions. Then, normally, the image is divided into 3 by 3 blocks of pixels. Each block becomes a pixel in the new image. Its gray scale is computed as the average of the pixels it contains. This procedure will produce an image of better quality if it preceded by a size based simplification. For example, all objects of size less than 3 pixels can be removed. Then a block with 8 white pixels and a black in the middle (noise) will produce a white pixel instead of gray in the new image. The two types of simplification can be combined. For example, all objects with contrast less than 20 and area less than 3 can be removed.

More generally, the compression process will apply to a dynamical image. First, the image is simplified as above. Then, we choose one or several frames adjacent to the frame A to be removed and add each cell of frame A to these frames. Next, we update the adjacency relation of the dynamical image by making each pair of frames adjacent to A adjacent to each other.

A Measure of the Integrity of a Porous or Cellular Material.

An elementary application of the present method is the following. Suppose we are given a piece of a porous material (e.g., a bone) as a 3D image. The object may have a very complicated structure with thousands of tunnels, voids, etc. We need to evaluate its integrity in comparison to other structures with the same density. The simplest example is when we need to find out whether the top is connected to the bottom. Using the present method, compute the homology of the image. Then the top is disconnected from the bottom if there is no 0-cycle with vertices from both top and bottom. In other words, the top and bottom are connected if there is a vertex in the top and a vertex in the bottom homologous to each other.

Further, this computation is combined with erosion as an imitation of the loss of density. At every step of the erosion procedure, the homology of the current image is computed and the connectedness is verified. Then the number of steps it takes to make top and bottom disconnected is a measure of connectedness. More precisely, it is a measure of resistance of this object to horizontal fracturing. This measure can be computed as the persistence with respect to erosion of those 0-cycles that intersect both top and bottom. Alternatively, one evaluates the persistence of the 0-cycle represented by two points, one in the top and one in the bottom (both top and bottom are typically assumed to be connected). This measure reflects the weakness of the bone.

This measure behaves appropriately with respect to affine transformations. For example, if the object's vertical dimension increases by a factor of 2, the measure will not change, as expected. If both of the horizontal dimensions increase by a factor of 2, the measure will increase by factor of 2, as expected.

If the image of the bone is gray scale, we use a dynamical image with two parameters: the gray scale threshold and the number of erosions. Just as above, the measure of the weakness is the persistence of the two-point 0-cycle. The persistence can be computed as a weighted sum of the number of frames for which the cycle exists.

Erosion imitates the development of osteoporosis. This measure of strength applied to bones affected by this disease is different from (and simpler than) ones that rely on the rod-plate structure (U.S. Pat. No. 6,975,894 titled “Digital Topological Analysis Of Trabecular Bone MR Images And Prediction Of Osteoporosis Fractures” to Wehrli, et al.). It is also different from the 3D-Line Skeleton Graph Analysis (LSGA) (“Combination Of Topological Parameters And Bone Volume Fraction Better Predicts The Mechanical Properties Of Trabecular Bone” by L. Pothuaud, B. Van Rietbergen, L. Mosekilde, and 0. Beuf, in the Journal of Biomechanics, 35 (2002), pp. 1091-1099). Even though LSGA starts with erosion, it is a topology preserving erosion used only for finding the skeleton of the bone structure. The skeleton is then evaluated for connectivity as a graph regardless of its thickness or its orientation with respect to the axis of the bone. Therefore, the main difference from the present measure is that the former is isotropic.

Here we use 0-cycles, and, therefore, 0^{th} Betti numbers (B₀), to describe the connectedness of a porous object. In the article “Combination Of Topological Parameters And Bone Volume Fraction Better Predicts The Mechanical Properties Of Trabecular Bone”, Supra, the 1^{st} Betti number (B₁) is considered a measure of “connectivity”. The rationale is that this number is the number of connections you can cut without making the object disconnected. This rationale, however, is valid only for 1-dimensional models of the 3D object. Unlike the present method, this approach also forces to take into account the density of the bone in a separate procedure.

The method applies similarly to the measurement of the integrity of membranes as 2-chains bounded by 1-cycles, or higher dimensional homology classes.

An alternative approach to the evaluation of the integrity of the bone is by treating the gray scale image as a probability distribution. For example, white is 1 (bone), black is 0 (void), and the number between 0 and 1 assigned to a voxel is the probability that this voxel contains bone. As before, the question is whether the top is connected to the bottom. The probability of this event is computed directly by standard techniques or via Monte-Carlo simulation. To take into account the loss of density one computes this probability for a sequence of images obtained by multiple applications of erosion.

To evaluate the integrity of a porous material this way one considers a 0-cycle C equal to the sum of two vertices, one from the top and the other from the bottom. These two points are connected to each other if there is a 1-chain K such that D*K=C, i.e., C is homologous to 0. The probability of the existence of such a K is a measure of integrity. If C is a k-cycle, the probability of the existence of K such that C=D*K is used to evaluate the likelihood of other topological features: k=1 for tunnels, k=2 for voids, etc. More precisely, the conditional probability is used: the probability that C is homologous to zero provided C exists.

Thus the probability that C is homologous to 0 is a measure of saliency of the feature represented by C, while the probability that it is not homologous to 0 is a measure of integrity of the object.

Texture Based Image Classification.

A known method of classification of images is based on matching their histograms of color distribution. The difference of the color histograms of two images is the measure of how dissimilar they are. However, if the image is broken into pieces and then arbitrarily reassembled, the histogram of the new image is identical to that of the original. The present algorithm collects data about the image in terms of its topological and geometric characteristics), such as the number of objects, their sizes etc. The matching of the distributions of these parameters provides a better measure of image similarity and can be used in an image retrieval system or a search procedure.

The following describes an image similarity measure based on distributions of objects, i.e., texture. Suppose there is a database of images. For simplicity assume that they are binary. As an image is added to the database, distributions (histograms) of given parameters are recorded. Such a parameter can be the size of an object within the image. In the general n-dimensional case, this parameter can be the size (as an integral) of k-cycles for any k=0, 1, . . . , n. Then, considering the distribution of sizes of objects can be used to distinguish an image of rocks from that of sand. Finding images with similar histograms narrows down the field of search. More precisely, two images are a match if the difference of their distributions is within the limits set by the user.

There may be other parameters, such as the number of objects per square inch. It could also be the distances from an object to the nearest (or the second nearest, etc, or the average distance). These parameters can be used to distinguish a uniform texture from an irregular formation. This data will tell a landscape from a portrait, or an individual from a group portrait. The parameters may be combined. For example we may combine the distribution of sizes with the distribution of distances from each object of particular size to the nearest object of this size. This creates a 2D joint histogram (3D if there are 3 parameters, etc), which is then compared to that of a potential match.

In addition, a dynamical image may be created by dilation (or another morphological operation) the original. Then, the distributions of sizes (or other parameters) are recorded for each frame. This data is recorded as a 2-dimensional array of integers—the number of objects of size x within the image after y steps of the dilation procedure is recorded at (x,y). Then, two images are a match if for some values of y, the difference of their distributions is within the limits set by the user. The image may be further modified by the morphing method described above.

In a different situation, if, for a given object, you need to find a match within the image, you first search for an object with similar measurements.

A Partition Based Image Similarity Measure.

The above method only provides a certain reduction in size of the database to be searched. After several matches have been found, their similarity to the original has to be evaluated. The following method applies especially well to small perturbations of the image. Such perturbations are small translations, rotations, and their combinations, enlargements, blurring, and other deformations, and minor noise.

Suppose we have two binary images of the same size. Create a dynamical image made of these two images. Essentially, this is a video with just two frames. It is processed by the present partition algorithm. In particular, each object is represented by a node in the graph and the objects in the first frame are connected to those of the second by edges. Now we do not have to compare the whole images to each other but instead compare each object or collections of objects in one frame to those objects in the other that it is connected to.

Consider first the simplest case when the perturbations are small with respect to the sizes of the objects in the image and distances between them. The result is that an object in the first image and its perturbed copy in the second overlap and they don't overlap others. Therefore, the change of size and shape of the object in the first image in comparison to those in the second can be measured. In particular, there will be just one object in the second frame corresponding to the one in the first. For example, this is the case when the picture was slightly moved or when the distortion was very minor. The easiest way to make the comparison quantitative is to choose the differences of the sizes of the objects (areas, volumes, other integrals) as the similarity measure. Thus, this measure is the sum of differences of sizes of all of these pairs of objects. In particular, in the case of a translation, this similarity measure will be zero.

Further, if we allow more general deformations, an object in the first frame may be broken down into several pieces in the second. These pieces will be still connected by the edges of the graph to the “parent” object in the first frame and none of the others. Then, we can compare an object in the first frame to the objects in the second it is connected to. This similarity measure is the sum of differences of sizes of all of objects in the first frame from the total size of their “children” in the second frame.

Suppose A is a collection of objects in one of the frames and B in the other. Let m be the total sum of sizes of objects in A minus the total sum of sizes of objects in B. If m<0, let m=0. Denote the result m(A,B).

In the general case, the merging and splitting is recorded as a bipartite graph: arrows go from the nodes on the left (first frame) to the nodes on the right (second frame) in an arbitrary way. Suppose A is a collection of objects in one of the frames. Let B be the collection of all objects in the other frame connected to the objects in A. Add m(A,B) for all collections A. Normalize the result with respect to the total size of all objects in the image.

Such a measure may be computed separately for collections of a given size, or sizes, or the number of objects. Further, this measure applied to a given area of the image instead of the whole image produces a “local” similarity measure. Application of local measures would detect the similarity between an image and its part and between images with missing parts.

Each connected component in this graph corresponds to a collection A of objects in the first frame and a collection B in the second. These two collections overlap. In terms of the overlap, the pair (A,B) is minimal in the sense that, first, A does not overlap objects in the second frame other than those in B and vice versa, and, second, A and B do not contain collections AA and BB, respectively, satisfying the first property. Then, the following similarity measure can be used. Compute the distance from the center of mass of A to that of B. Then add the results for all such collections A.

Of course, two objects of different shapes may have the same size and, therefore, the same similarity measure. This problem is addressed firstly by applying local similarity measures. Secondly, the more objects the image contains, the less likely false positives are. Also, multiple applications of the similarity measure will improve its performance. Apply erosion to both images and then evaluate the similarity measure of the resulting pair. During erosion some objects will break into pieces which will make the measure more accurate.

If we have to compare two color images, or video sequences, we represent them as dynamical images first and then compare their frames to each other as above.

Thus, for an image and its small perturbation the measure will be low. Therefore, if the measure is large, the images are far apart either in terms of shape or in terms of location. To detect the similarity of two arbitrary images, their alignment would have to precede the evaluation of similarity measures.

An Image Alignment Method Based on Computation of Centers of Mass.

A common approach to image registration is minimization of a similarity measure over all possible alignments of the two images. The above measure may serve as one. However, a direct search for several best alignments followed by the evaluation of a similarity measure is a more efficient approach.

To align two objects you need to establish a correspondence between 2 points in one 2D image and 2 points in the other (3 points if reflection is allowed), 3 points for 3D images, etc. The points must be in general position. The center of mass is normally chosen as the first point. To find the orientation of the image with respect to the center of mass, higher order moments have been applied.

Another approach is to find the center of mass of these objects but with redistributed weight, as follows. Suppose f(x) and g(x) are the gray levels at the point x of the first and second images respectively. Suppose their centers of mass are c and d. The center of mass is found via integration of gray level function (treated as the density function) over the whole image. Let h be a “radial” function with respect to c: h(x)=q(r), where q is some function and r is the distance from x to c. Let k be the corresponding radial function with respect to d: k(x)=h(x+c−d). Then we can create two new distributions of weight, fh and gk (or f+h and g+k, etc). Then, let the centers of mass of the objects corresponding to these distributions be the second aligned pair of points. To find another pair, choose a different function q.

However, all these pairs of points will be identical, regardless of the choice of q, if the original images are symmetric with respect to their centers of mass. Even if these images are not exactly symmetric, the pairs of points will be close to each other and, therefore, may provide an unreliable alignment. Other symmetries may result in points not in general position. To deal with this problem, the partition of the images may be used. Suppose A is a collection of objects in the first image, then, find a collection B (or collections) of objects in the second image with close total weight. The centers of mass of A and B will be an aligned pair of points. Further, the centers of mass of A and B with redistributed weight will provide more points, as above. This procedure may be repeated for all collections A. An additional advantage of this approach is that it allows matching images with missing parts.

The result may be a number of ways to align the images. The best one is chosen by means of the similarity measure described above. Further, the more objects in the image, the more ways to align the images. Just as above, erosion will make objects to break into pieces and achieve the desired goal. A more advanced way to create more objects in the picture is to apply the feature extraction methods described above.

The matching procedure may be preceded by simplification. This will provide a cruder but faster matching. In addition, matching of objects with different topologies becomes possible. First remove from both images all k-cycles with k>0 and then match and compare the results by the above procedures. This allows matching of a wheel and a tire.

Matching of objects, i.e., 0-cycles, has only been used. It is also possible to match k-cycles with k>0. These cycles can be extracted from both images and represented as cell complexes by methods described above. Matching these complexes in size and shape will provide new alignment points for the two images. For example, if each of the two 3D images contains a complicated void, the centers of mass of these voids may be aligned.

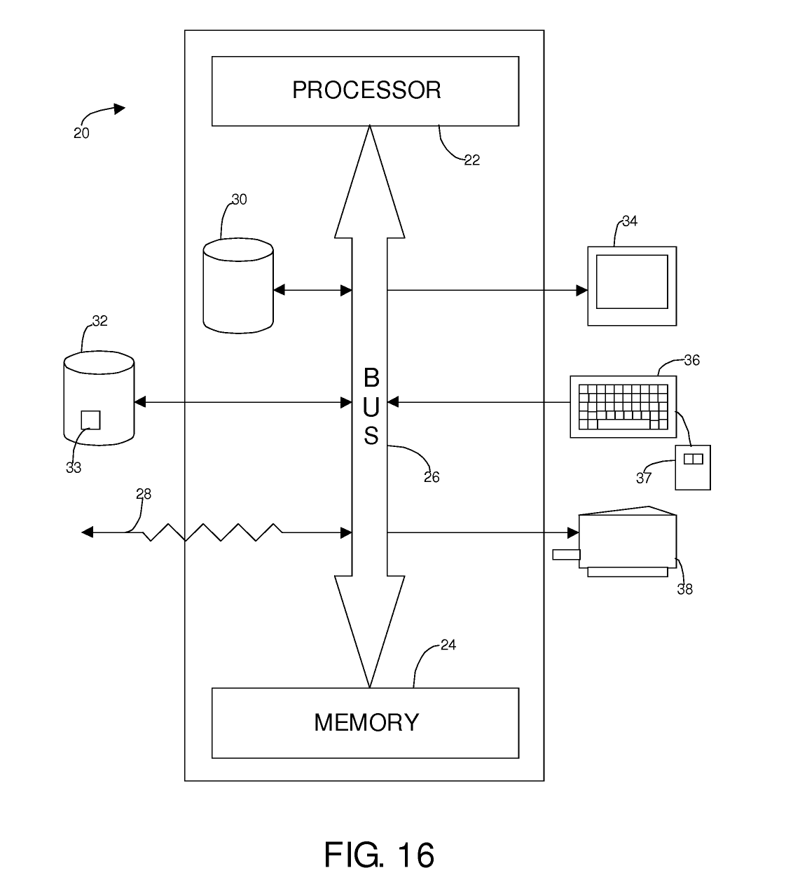

FIG. 16 is a block diagram illustrating a General Purpose Computer 20. The General Purpose Computer 20 has a Computer Processor 22, and Memory 24, connected by a Bus 26. Memory 24 is a relatively high speed machine readable medium and includes Volatile Memories such as DRAM, and SRAM, and Non-Volatile Memories such as, ROM, FLASH, EPROM, EEPROM, and bubble memory. Also connected to the Bus are Secondary Storage 30, External Storage 32, output devices such as a monitor 34, input devices such as a keyboard 36 with a mouse 37, and printers 38. Secondary Storage 30 includes machine-readable media such as hard disk drives, magnetic drum, and bubble memory. External Storage 32 includes machine-readable media such as floppy disks, removable hard drives, magnetic tape, CD-ROM, and even other computers, possibly connected via a communications line 28. The distinction drawn here between Secondary Storage 30 and External Storage 32 is primarily for convenience in describing the invention. As such, it should be appreciated that there is substantial functional overlap between these elements. Computer software such test programs, operating systems, and user programs can be stored in a Computer Software Storage Medium, such as memory 24, Secondary Storage 30, and External Storage 32. Executable versions of computer software 33, such as computer imaging software can be read from a Non-Volatile Storage Medium such as External Storage 32, Secondary Storage 30, and Non-Volatile Memory and loaded for execution directly into Volatile Memory, executed directly out of Non-Volatile Memory, or stored on the Secondary Storage 30 prior to loading into Volatile Memory for execution.

Those skilled in the art will recognize that modifications and variations can be made without departing from the spirit of the invention. Therefore, it is intended that this invention encompass all such variations and modifications as fall within the scope of the appended claims.

What is claimed is:

1. In a model of a video as a sequence of binary 2D images, wherein the improvement comprises a dynamical image: a time-dependent stream of pluralities of objects called frames, aligned with each other and an adjacency relation defined on these frames.

2. A method of analyzing time-dependent images wherein:
homology groups of a filtration sequence of simplicial complexes are incrementally computed; and comprising steps of:
A) processing an input image by providing a representation of the input image as a dynamical image comprising a set of frames;
B) analyzing the dynamical image by providing:
(1) a set of topological features of the set of frames of the dynamical image;
(2) a set of relations between the topological features of a pair of adjacent frames comprising at least one of: matching, appearing, disappearing, merging, and splitting of topological features.

3. The method in claim 2 wherein the set of topological features computed by the analyzing in step (B) comprise a set of homology groups of each frame.

4. The method in claim 3 wherein parts (1) and (2) of the analyzing in step (B) are executed by applying a Mayer-Vietoris theorem to a difference of a pair of adjacent frames.

5. The method in claim 3, further comprising:
C) evaluating a saliency of a topological feature of the input image by computing a predetermined combination of sizes of a homology class corresponding to the topological feature in all frames of a lifespan of the homology class.

6. The image analysis method of claim 5, further including a classification step (D) comprising:
computing a distribution of the characteristics computed during evaluation step (C) of topological features of the dynamical image, and combinations of the characteristics.

7. The method in claim 6, further including varying the dynamical image, prior to the execution of the classification step (C), by at least one of:
applying morphological operations to the dynamical image,
removing homology classes from the dynamical image, and
creating new homology classes in the dynamical image.

8. The method in claim 5 wherein the dimension of the homology class is 0 and a size of the homology class in a frame is an integral over components corresponding to the homology class.

9. The method in claim 5 wherein a size of the homology class in a frame is an integral over an element of the homology class.

10. The method in claim 5 wherein a predetermined combination of sizes of the homology class in all frames of the lifespan of the homology class is a sum of the sizes.

11. The method in claim 10 wherein:
the dynamical image is a sequence of binary images created by thresholding a gray scale image,
a parameter of the dynamical image is the threshold of the gray scale image,
the homology class is that of an object in the image,
a size of the homology class in a frame is an area of the object in the frame,
whereby the method evaluates an importance of the object as a volume of a region bounded by a part of a graph of a gray scale function over the object.

12. The method in claim 10 wherein:
the dynamical image is a sequence of binary images created by thresholding a gray scale image,
a parameter of the dynamical image is a threshold of the gray scale image,
the homology class is that of an object in the gray scale image,
a size of the homology class in all frames of the lifespan of the homology class is equal to 1, and
whereby the method evaluates the importance of the object as a contrast thereof.

13. The method in claim 10 wherein:
the dynamical image is a sequence of frames of a video,
a parameter of the dynamical image is a number of the frame,
the homology class is that of an object in the video,
a size of the homology class in all frames of a lifespan of the homology class is equal to 1, and
whereby the method evaluates an importance of the object as an amount of time it is present on a screen.

14. The method in claim 10 wherein:
the input image is a gray-scale image that represents an object,
a first parameter of the dynamical image is a threshold of the gray-scale image of the object,
a second parameter of the dynamical image is a number of morphological operations applied to each threshold,
a size of the homology class in all frames of a lifespan of the homology class is equal to 1, and
whereby the method evaluates a perceived integrity of the object in terms of a likelihood of appearance of the homology class, such as a break, a tunnel, or a void, resulting from a loss of density.

15. The method in claim 14 wherein:
the homology class is a 0-homology class of a collection of points in the object,
whereby the method evaluates a degree of integrity of the object in terms of a likelihood of a loss of connectivity between a plurality of parts of the object, as a measure of resistance of the object to fracturing between the parts resulting from a loss of density.

16. The method in claim 14 wherein:
the homology class is a 1-homology class of a closed curve in the object,
whereby the method evaluates a degree of integrity of the object in terms a likelihood of a loss of separation of areas outside of the object adjacent to two opposite sides of a membrane on a closed curve contained in the object, as a measure of resistance of all such membranes to a tear resulting from a loss of density.

17. The method in claim 14 wherein:
the homology class is a 2-homology class of a closed surface in the object, and
whereby the method evaluates a degree of integrity of the object in terms a likelihood of an appearance of a bubble inside a closed surface, as a measure of resistance of a region bounded by the closed surface to an internal tear resulting from a loss of density.

18. The method in claim 3 wherein the frames are subcomplexes of a same cubical complex which is a rectangular array; the analyzing in step (B) is executed by a method comprising the substeps of:
a) designating a frame from the set of frames as a designated frame;
b) representing the designated frame by an array N, wherein each entry in the array N has a value selected from 0 and 1;
c) selecting a frame adjacent to the designated frame and representing the adjacent frame by an array P, wherein each entry in array P has a value selected from 0 and 1;
d) selecting a cell of the designated frame as a selected cell;
e) after each substep (d), reading an entry Q in P and an entry R in N corresponding to the selected cell;
f) after each substep (e), if Q=0 and R=1, adding the selected cell to the designated frame; and if Q=1 and R=0, removing the selected cell from the designated frame;
g) after each substep (f), updating a set of homology groups of the designated frame;
h) repeating substeps (d), (e), (f), and (g) until each cell in the designated frame has been selected as the selected cell; and
i) for each adjacent frame after completing substeps (d), (e), (f), (g), and (h) updating a set of homology groups of the adjacent frame;
whereby the set of homology groups of the designated frame is incrementally computed as cells are added and removed resulting in the computation of the set of homology groups of the adjacent frame in terms of set of homology groups of the designated frame;
j) repeating substeps (a) through (i) with a different frame as the designated frame until each of the set of frames has been designated.

19. The method in claim 18 wherein the set of homology groups is updated in substep (g) by a method comprising:
(i) in order to add a k-cell C:
computing its boundary B=D*C;
if there is a (k−1)-generator A homologous to B or −B, removing the homology class [A] of A provided k>1;
if there is no such A, finding a k-chain K such that B=D*K, and adding the homology class [K−C] of K−C;
(ii) in order to remove a k-cell C:
computing its boundary B=D*C;
if there is a k-chain L with its boundary D*L homologous to B or −B, removing the homology class [C−L] of C−L;
if there is no such L, adding the homology class [B] of B provided k>1.

20. The method in claim 18 wherein the dimension of the image is equal to 2 and the set of homology groups are updated by a method comprising:
I. to add a 2-cell C having a plurality of vertices and a plurality of edges to the image:
(1) add each of the plurality vertices of the cell C unless a vertex is a vertex of another cell,
(2) add each of the plurality of edges unless an edge E is an edge of another cell following a rule comprising:
if the edge E connects two different 0-cycles, merge the two different 0-cycles into a new 0-cycle;
if the edge E connects a 0-cycle to itself, split the 0-cycle into a new 1-cycle and a new 0-cycle; and
if the edge E connects a 1-cycle to itself, split the 1-cycle into two new 1-cycles, and
(3) add the cell C itself by removing a 1-cycle consisting of its plurality of edges of the cell;
II. to remove a cell C having a plurality of edges and a plurality of vertices from the image:
(1) remove the cell itself by creating a 1-cycle consisting of the four edges of the cell,
(2) remove each of the plurality of edges provided an edge E is not an edge of another cell following a rule comprising:
if the edge E is a part of a 0cycle and a part of a 1cycle, merge the 0cycle and the 1-cycle into a new 0cycle;
if E is only a part of a 0-cycle, split the 0-cycle into two new 0-cycles;
if E is part of two 1-cycles, merge the two 1-cycles into a new 1-cycle, and
(3) remove each of the plurality of vertices of the cell C unless the vertex is a vertex of another cell.

21. The method in claim 2, further comprising:
computing topological features of the complements of the frames.

22. The image analysis method of claim 2, further comprising:
computing topological features of each of the frames relative to a part assigned to the frame.

23. The method in claim 2 wherein the topological features computed by the analyzing step (B) are a set of cohomology groups of the frames.

24. The method in claim 2 wherein the topological features computed by the analysis step (B) are the homotopy groups of the frames.

25. The method in claim 2 wherein:
the input image is a t-dimensional array of objects with s-vectors assigned to their points, and
the input processing step (A) is executed by creating the dynamical image with t temporal parameters and s color-like parameters, by following the procedure:
if a k^{th} component of a vector assigned to a point is larger than or equal to a value of the k^{th} color-like parameter, the point is included in a binary image that is a frame of a dynamical image corresponding to a given combination of parameters, whereby the method will convert an image with s parameters into a dynamical image.

26. The method in claim 2, further comprising a simplification step (D) comprising:
removing a topological feature from the dynamical image if the entry, created by the analyzing in step (B), corresponding to a topological feature is marked as inactive,
whereby the method will provide the user with complete control over a simplification process.

27. The method in claim 26 wherein: the input image is a time-dependent t-dimensional array of cell complexes with s-vectors assigned to each cell, further comprising an output processing step (E) executed by following a procedure:
for each cell of the dynamical image as a selected cell and for each p=1, 2, . . . , s, if the selected cell belongs to a k^{th} element of a sequence of cell complexes corresponding to a p^{th} color-like parameter of the dynamical image but not to a (k+1)^{th} element, then a p^{th} coordinate of a vector assigned to the selected cell is set equal to k, whereby the dynamical image will be converted into an original format of the input image.

28. The method in claim 2 wherein the input image is a sequence of images and further comprises a tracking step comprising substeps of:
a) detecting a set of objects as a set of topological features of the dynamical image;
b) computing a velocity for each of the set of objects and a rate of change of sizes and shapes of each of the set of objects;
c) predicting locations, sizes, and shapes of each of the set of objects in a next frame, and
d) matching each of the set of objects to a corresponding object in the next frame,
whereby the method will track objects in the sequence.

29. A method of creating a new subcomplex with Betti numbers within a specified range from a given subcomplex of an ambient cell complex by a topologically constrained transformation comprising the steps of:
A) creating a target subcomplex with Betti numbers within the specified range;
B) creating a current subcomplex as a copy of the given subcomplex;
C) repeatedly morphing the current subcomplex toward the target subcomplex by adding and removing cells of the current subcomplex and stopping no later than the Betti numbers of the current subcomplex fall within the specified range; and
D) repeatedly morphing the current subcomplex toward the given subcomplex as a new target subcomplex by adding and removing cells of the current subcomplex, so that each adding or removing step is cancelled if the step results in the Betti numbers of the current subcomplex outside the specified range of Betti numbers, until the current subcomplex does not change; and
whereby the method cuts the given subcomplex into pieces and adds other topological features to the given subcomplex providing a resulting subcomplex.

30. The method as claimed in claim 29 wherein morphing the current subcomplex toward the target subcomplex in steps (C) and (D) comprises a sequence of operations each selected from a group comprising:
a) adding to the current subcomplex a cell adjacent to the current subcomplex, provided the cell belongs to the target subcomplex, and
b) removing from the current subcomplex a cell adjacent to the complement of the current subcomplex, provided the cell does not belong to the target subcomplex.

31. The method as claimed in claim 29 wherein an empty subcomplex is chosen as the target subcomplex, whereby the method executes by erosion of the given subcomplex followed by topology preserving dilation.

32. The method as claimed in claim 31 wherein a cell is added unless this step creates a cycle that belongs to a given homology class, whereby the method removes the homology class from the subcomplex by breaking all cycles in the homology class.

33. The method as claimed in claim 31 wherein the range of Betti numbers is chosen to have the k^{th} Betti number larger than that of the given subcomplex, whereby the method creates a subcomplex with more k-homology classes than the given subcomplex.

34. The method in claim 33, further comprising creating a new subcomplex containing all cells, and faces of all cells, of at least one member of the new homology classes, whereby the method creates and extracts pieces and other homology classes from the subcomplex as cell complexes.

35. The method in claim 29 wherein the ambient cell complex is chosen as the target subcomplex whereby the method executes by dilation of the given subcomplex followed by topology preserving erosion.

36. The method in claim 35 wherein the given subcomplex comprises cells that contain points of a given point cloud located in an ambient cell complex, whereby the method represents the point cloud as a subcomplex with Betti numbers within the specified range.

37. The method in claim 35 wherein,
for a given k-homology class of an original cell complex, an ambient cell complex is chosen with the k-Betti number equal to 0,
the given subcomplex is chosen to comprise all cells of a predetermined collection within the k-homology class and their faces, and
the method further comprises a step of:
adding the resulting subcomplex to the original cell complex, whereby the method removes the given k-homology class from the original cell complex by adding a collection of (k+1)-cells that will close the k-homology class with a membrane, leaving a rest of the original cell complex unaffected.

38. A method of removing a plurality of frames from a dynamical image, comprising, for each frame A in the plurality of frames, the steps of:
A) finding all topological features in the frame A that have a predetermined plurality of combinations of characteristics outside given ranges;
B) removing the topological features found in step (A) from the dynamical image;
C) choosing a set of one or several frames adjacent to the frame A and adding each cell of the frame A to the set of one or several frames;
D) updating an adjacency relation of the dynamical image by making each pair of frames adjacent to the frame A adjacent to each other; and
E) removing the frame A from the dynamical image.

39. The method in claim 38 wherein:
the dynamical image is an image given by an intensity function,
the plurality of frames is a plurality of values of the intensity function,
the topological features are objects in the frame A, and
the predetermined plurality of combinations of characteristics comprise contrasts and sizes of the objects, and
whereby the method provides a compression of a simplification of the image by reducing a number of bits per pixel.

40. A method of measuring a similarity of two aligned images, computed as a difference of a total size of a collection A of objects in one of the two aligned images and a total size of the collection B of all objects in an other of the two aligned images overlapping A, or zero if the difference is negative, added over all collections A in a given plurality of collections of objects.

41. The method in claim 40, further including:
varying the two aligned images by applying morphological operations to the two aligned images, removing homology classes from the two aligned images, and creating new homology classes in the two aligned images, prior to the execution of the method.

42. A method of finding a point in each of two given images represented by density functions f(x) and g(y) respectively, where x is a position in a first image and y is a position in a second image, as a way to align the first image and the second image, comprising the steps of:
A) finding the centers of mass a and b of the first image and the second image;
B) choosing a function of two variables p(z,r);
C) creating two new density functions F(x)=p(f(x),|x−a|)) and G(y)=p(g(y),|y−b|)), where |x−a| is a distance from x to a, |y−b| is a distance from y to b; and
D) computing centers of mass c and d of the first image and the second image with densities F(x) and G(y), respectively; and
whereby the method assigns a new density value to each pixel depending only on its current density and its distance to a in the first image and b in the second image, and provides a pair c, d of aligned points for each choice of the function p.

43. The method in claim 42, further including:
varying the first image and the second image by applying morphological operations to the first image and the second image, removing homology classes from the first image and the second image, and creating new homology classes in the first image and the second image, prior to the execution of the method.

44. A method of evaluating a saliency of a topological feature in an image of an object given by a density distribution function comprising computing the probability that a cycle corresponding to the topological feature is not homologous to zero, whereby the method evaluates a probability of a loss of integrity of the object.

45. The method in claim 44, further including
varying the image by applying morphological operations to the image, prior to the execution of the method.

46. The method in claim 44 wherein:
the cycle is a 0-cycle of a plurality of points in the object, and
whereby the method evaluates a probability of a loss of connectivity between a plurality of parts of the object, as a measure of resistance of the object to fracturing between the plurality of parts.

47. The method in claim 44 wherein:
the cycle is a 1-cycle of a closed curve in the object, and
whereby the method evaluates a probability of a loss of separation of areas outside of the object adjacent to two opposite sides of a membrane on a closed curve contained in the object, as a measure of resistance of all such membranes to a tear.

48. The method in claim 44 wherein:
the cycle is a 2-cycle of a closed surface in the object, and
whereby the method evaluates a probability of an appearance of a bubble inside a closed surface, as a measure of resistance of a region bounded by the closed surface to an internal tear.
